(19) United States
(12) Patent Application Publication
(10) Pub. No.: US 2014/0146876 A1
(43) Pub. Date: May 29, 2014

(54) MOVING PICTURE CODING APPARATUS, MOVING PICTURE CODING METHOD, MOVING PICTURE CODING PROGRAM, AND MOVING PICTURE DECODING APPARATUS

(71) Applicant: JVC KENWOOD Corporation, Yokohama-shi (JP)

(72) Inventors: Hideki TAKEHARA, Yokosuka-shi (JP); Shigeru FUKUSHIMA, Yokosuka-shi (JP); Toru KUMAKURA, Yokohama-shi (JP); Masayoshi NISHITANI, Yokosuka-shi (JP); Kazumi ARAKAGE, Yokosuka-shi (JP)

(73) Assignee: JVC KENWOOD Corporation, Yokohama-shi (JP)

(21) Appl. No.: 14/092,598

(22) Filed: Nov. 27, 2013

(30) Foreign Application Priority Data
Nov. 28, 2012 (JP) 2012-259417

(51) Int. Cl. H04N 7/26; H04N 7/36

(52) U.S. Cl. CPC H04N 19/00036; H04N 19/00278; H04N 19/00678; H04N 19/00684
USPC 375/240.02

(57) ABSTRACT

An inter mode coding unit codes the information regarding the motion information of either one of a merge mode and a motion vector difference mode. A block size information coding unit codes the shape of the block on which the motion compensation prediction is performed. An evaluation inter mode setting unit sets the shape of the block, on which the motion compensation prediction is performed, then selects at least one of the merge mode and the motion vector difference mode, according to the shape thereof set. An inter mode determining unit determines an inter mode of the information regarding the motion information to be coded by the inter mode coding unit in the selectable inter mode.

### BACKGROUND OF THE INVENTION

1. Field of the Invention

The present invention relates to a moving picture coding and decoding technique using motion compensation prediction, and more particularly, to a moving picture coding and decoding technique for coding and decoding motion information used in the motion compensation prediction.

2. Description of the Related Art

Motion compensation prediction is used in typical moving picture compression and coding. In this technique of motion compensation prediction, a target picture or a picture of interest is first divided into smaller-size blocks, and a decoded picture is used as a reference picture. Then, based on an amount of motion indicated by a motion vector, a signal, which has been moved to a reference block of the reference picture from a block to be processed in the target picture, is generated as a predictive signal. There are two ways to achieve the motion compensation prediction; one is a prediction done unidirectionally by use of a single motion vector, and the other is a prediction done bidirectionally by use of two motion vectors.

In the moving picture compression and coding such as MPEG-4 AVC/H.264 (hereinafter referred to simply as “AVC (Advanced Video Coding)” also), the size of a block with which to perform motion compensation prediction is finer and variable, thereby enabling a highly accurate motion compensation prediction. At the same time, when the block is of finer and variable size, there arises a problem where the amount of computation necessary for motion vectors becomes extremely huge.

In the light of this, a temporal direct-mode motion compensation prediction that realizes the motion compensation prediction without the transmission of coding vectors is used in the AVC. In this temporal direct-mode motion compensation prediction, attention is focused on a temporal continuity of motion, and a motion vector of a reference block located at the same position as a block to be processed is used as the motion vector of the block to be processed.

Disclosed in Reference (1) in the following Related Art List is a method that realize motion compensation prediction without the transmission of coded vectors. In this method, attention is focused on a spatial continuity of motion, and a motion vector of a processed block that neighbors a block to be processed is used as the motion vector of the block to be processed.

### RELATED ART LIST

(1) Japanese Unexamined Patent Application Publication (Kokai) No. Hei10-276439.

Simply combining the method disclosed in Reference (1) with the conventional method for transmitting a motion vector difference merely increases the processing amount but does not increase the processing rate to enhance the coding efficiency, as compared with the increased processing amount. Thus this is a problem to be resolved in the conventional practice.

### SUMMARY OF THE INVENTION

The present invention has been made in view of the foregoing circumstances, and a purpose thereof is to provide a moving picture coding technique and a moving picture decoding technique capable of efficiently achieving a balance (tradeoff) between the processing amount and the coding efficiency.

In order to resolve the above-described problems, a moving picture coding apparatus according to one embodiment of the present invention performs motion compensation prediction, and the apparatus includes: an inter mode coding unit configured to code information regarding motion information of either one of first and second inter modes, wherein the first inter mode is a merge mode, where the motion information of a block on which the motion compensation prediction is performed is selected from a motion information candidate list derived from motion information of coded blocks, and the second inter mode is a motion vector difference mode, where a motion vector difference is coded; a block-size information coding unit configured to code a shape of the block on which the motion compensation prediction is performed; and an inter mode setting unit configured to set the shape of the block, on which the motion compensation prediction is performed, configured to make selectable at least one of the merge mode and the motion vector difference mode, according to the shape thereof set, and configured to determine an inter mode of information regarding the motion information to be coded by the inter mode coding unit in the selectable inter mode.

Another embodiment of the present invention relates to a moving picture coding method. The method is a method for performing motion compensation prediction, and the method includes: an inter mode coding process of coding information regarding motion information of either one of first and second inter modes, wherein the first inter mode is a merge mode, where the motion information of a block on which the motion compensation prediction is performed is selected from a motion information candidate list derived from motion information of coded blocks, and the second inter mode is a motion vector difference mode, where a motion vector difference is coded; a block-size information coding process of coding a shape of the block on which the motion compensation prediction is performed; and an inter mode setting process of setting the shape of the block, on which the motion compensation prediction is performed, making selectable at least one of the merge mode and the motion vector difference mode, according to the shape thereof set, and determining an inter mode of information regarding the motion information to be coded by the inter mode coding process in the selectable inter mode.

Still another embodiment of the present invention relates to a moving picture decoding apparatus. The decoding apparatus includes: an inter mode decoding unit configured to decode information regarding motion information of either one of first and second inter modes, wherein the first inter mode is a merge mode, where the motion information of a block on which the motion compensation prediction is performed is selected from a motion information candidate list derived from motion information of coded blocks, and the second inter mode is a motion vector difference mode, where a motion vector difference is coded; a block-size information decoding unit configured to decode block-size information where a shape of the block, on which the motion compensation prediction is performed, have been coded; and a bitstream decoding unit configured to decode a bitstream where the information regarding the motion information of either one of the first and second inter modes has been coded, according to the block-size information.

Optional combinations of the aforementioned constituting elements, and implementations of the invention in the form of methods, apparatuses, systems, recording media, computer programs and so forth may also be practiced as additional modes of the present invention.

### BRIEF DESCRIPTION OF THE DRAWINGS

Embodiments will now be described by way of examples only, with reference to the accompanying drawings, which are meant to be exemplary, not limiting and wherein like elements are numbered alike in several Figures in which:

FIG. 1 illustrates a structure of a moving picture coding apparatus according to a first embodiment;

FIGS. 2A and 2B each illustrates an exemplary division of CU;

FIG. 3 illustrates a structure of an LCTB bitstream generator;

FIG. 4 is a flowchart showing an operation of an LCTB bitstream generator;

FIG. 5 illustrates a structure of a CTB evaluation unit;

FIGS. 6A to 6C illustrate partition types;

FIG. 7 illustrates neighboring partitions;

FIG. 8 illustrates an example of a merge candidate list;

FIG. 9 illustrates an inter mode or inter modes where each CU size can be used;

FIGS. 10A and 10B illustrate CTB having the same motion information as a partition type of 2N×N;

FIGS. 11A and 11B illustrate neighboring partitions whose partition types are 2N×N and N×2N, respectively;

FIG. 12 illustrates another exemplary inter mode(s) usable in each CU size;

FIG. 13 illustrates a structure of an inter mode determining unit;

FIG. 14 is a flowchart showing an operation of an inter mode determining unit;

FIG. 15 illustrates a merge mode evaluation unit;

FIG. 16 illustrates a structure of a merge candidate list constructing unit;

FIGS. 17A and 17B each illustrates a syntax;

FIG. 18 illustrates a syntax;

FIG. 19 illustrates a structure of a moving picture decoding apparatus according to a first embodiment;

FIG. 20 illustrates a structure of a motion information reproduction unit;

FIG. 21 illustrates inter modes, usable in each CU size, according to a second embodiment;

FIG. 22 illustrates inter modes, usable in each CU size, according to a third embodiment;

FIGS. 23A and 23B illustrate how motion information is replaced with a representative value of block size 16×16;

FIGS. 24A to 24D illustrate new partition types in a fifth embodiment;

FIG. 25 illustrates an inter mode or inter modes, usable in each CU size, according to a fifth embodiment; and

FIGS. 26A and 26B illustrate a combination of evaluation values of partition 0 and partition 1.

### DETAILED DESCRIPTION OF THE INVENTION

The invention will now be described by reference to the preferred embodiments. This does not intend to limit the scope of the present invention, but to exemplify the invention.

### First Embodiment

A description is given hereinbelow of a moving picture coding apparatus, a moving picture coding method, a moving picture coding program, and a moving picture decoding apparatus, a moving picture decoding method and a moving picture decoding program according to preferred embodiments of the present invention with reference to drawings. The same or equivalent components in each drawing will be denoted with the same reference numerals, and the repeated description thereof will be omitted.

(The Structure of a Moving Picture Coding Apparatus 100)

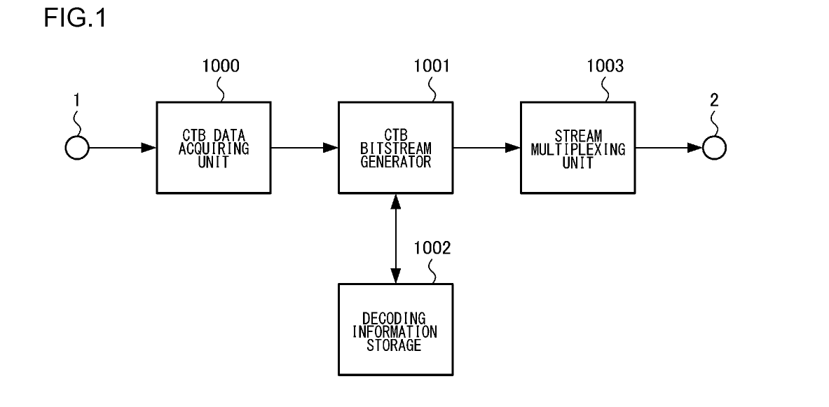

FIG. 1 is a diagram to explain a structure of the moving picture coding apparatus 100 according to a first embodiment. The moving picture coding apparatus 100 includes an LCTB (Largest Coding Tree Block) picture data acquiring unit 1000, an LCTB bitstream generator 1001, a decoding information storage 1002, and a stream multiplexing unit 1003

The moving picture coding apparatus 100 is realized by hardware, such as an information processing apparatus, equipped with a central processing unit (CPU), a frame memory, a hard disk and so forth. Activating these components achieves the functional components described as follows.

In the moving picture coding apparatus 100, an inputted picture signal is divided in units of largest coding tree block (LCTB) composed of 64 pixels (horizontal)×64 pixels (vertical) (hereinafter referred to as 64×64), and the divided LCTBs are coded, in a raster scan order, starting from an upper left corner. A description is given hereunder of a function and an operation of each component of the moving picture coding apparatus 100.

(LCTB Picture Data Acquiring Unit 1000)

An LCTB picture data acquiring unit 1000 acquires a picture signal of LCTB to be processed, from picture signals fed through a terminal 1, based on the positional information of LCTB and the size of LCTB and then supplies the acquired picture signal of LCTB to an LCTB bitstream generator 1001.

(CTB)

A coding tree block (CTB) is described here. CTB is of a quad tree structure. CTB sequentially becomes ones the size of each of which is ¼ of previous one such that the previous one is divided into two both horizontally and vertically. The four CTBs, which have been divided, are processed in a Z-scan order. CTB of size 64×64, which is the largest CTB, (hereinafter referred to as “64×64 CTB”) is the LCTB (Largest Coding Tree Block).

(CU)

A picture signal of CTB, which is not further divided, is intra-coded or inter-coded as a coding unit(CU).

(CTB and CU)

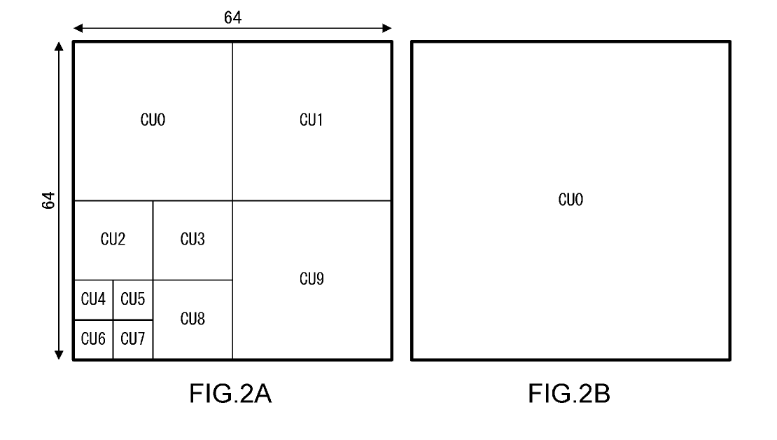

FIGS. 2A and 2B are diagrams each to explain an exemplary division of CU. In the example of FIG. 2A, an LCTB is divided into ten CUs. CU0, CU1 and CU9 are each a coding unit of 32×32 whose number of divisions is one. CU2 and CU3 are each a coding unit 16×16 whose number of divisions is two. CU4, CU5, CU6 and CU7 are each a coding unit 8×8 whose number of divisions is three. In the example of FIG. 2B, an LCTB is not divided at all and is therefore composed of a single CU.

In the present embodiment, the maximum size of CTB is 64×64 and the minimum size thereof is 8×8 but the sizes thereof are not limited thereto as long as the maximum size of CTB is greater than or equal to the minimum size thereof.

(LCTB Bitstream Generator)

The LCTB bitstream generator 1001 codes a picture signal of LCTB fed from the LCTB picture data acquiring unit 1000 so as to generate a bitstream and then supplies the generated bitstream to the stream multiplexing unit 1003. Also, an operation based on a local decoding is performed and then the motion information and the locally decoded reproduction picture (locally reconstructed picture) are supplied to the decoding information storage 1002. A detailed description of the motion information will be given later.

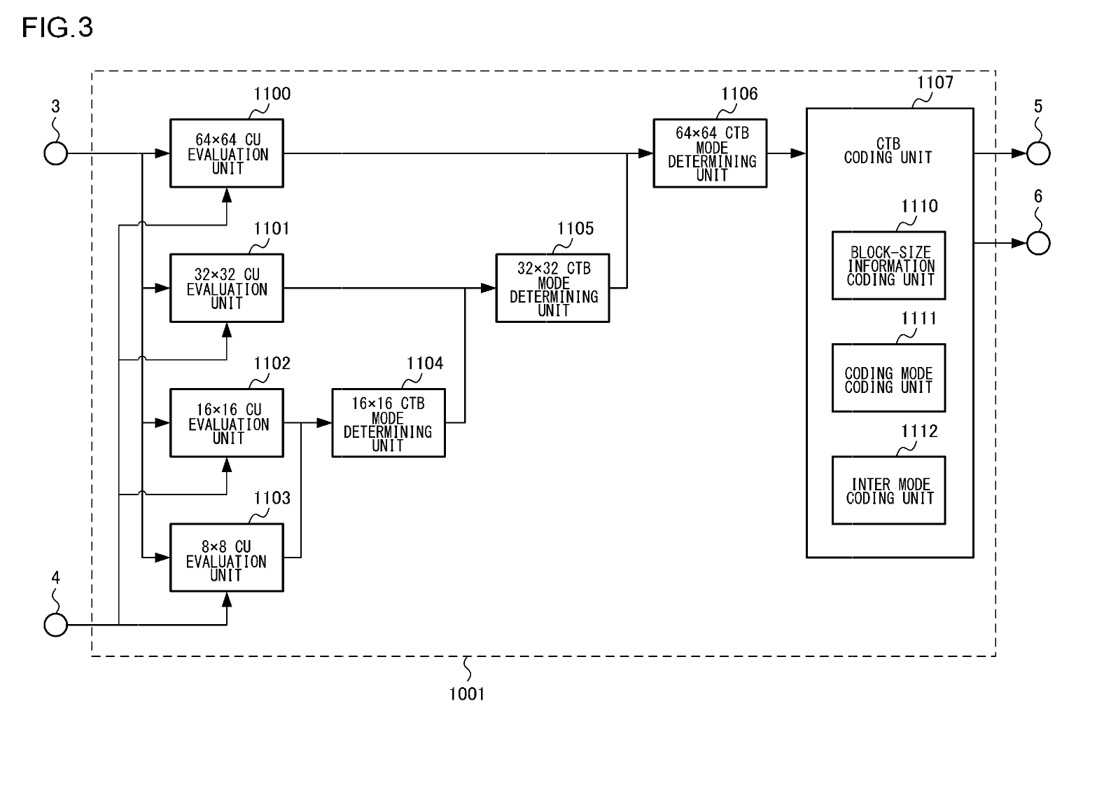

A structure of the LCTB bitstream generator 1001 is now described. FIG. 3 is a diagram to explain the structure of the LCTB bitstream generator 1001. The LCTB bitstream generator 1001 includes a 64×64 CU evaluation unit 1100, a 32×32 CU evaluation unit 1101, a 16×16 CU evaluation unit 1102, an 8×8 CU evaluation unit 1103, a 16×16 CTB mode determining unit 1104, a 32×32 CTB mode determining unit 1105, a 64×64 CTB mode determining unit 1106, and a CTB coding unit 1107. A terminal 3 is connected to the LCTB picture data acquiring unit 1000. A terminal 4 is connected to the decoding information storage 1002. A terminal 5 is connected to a terminal 2. A terminal 6 is connected to the decoding information storage 1002.

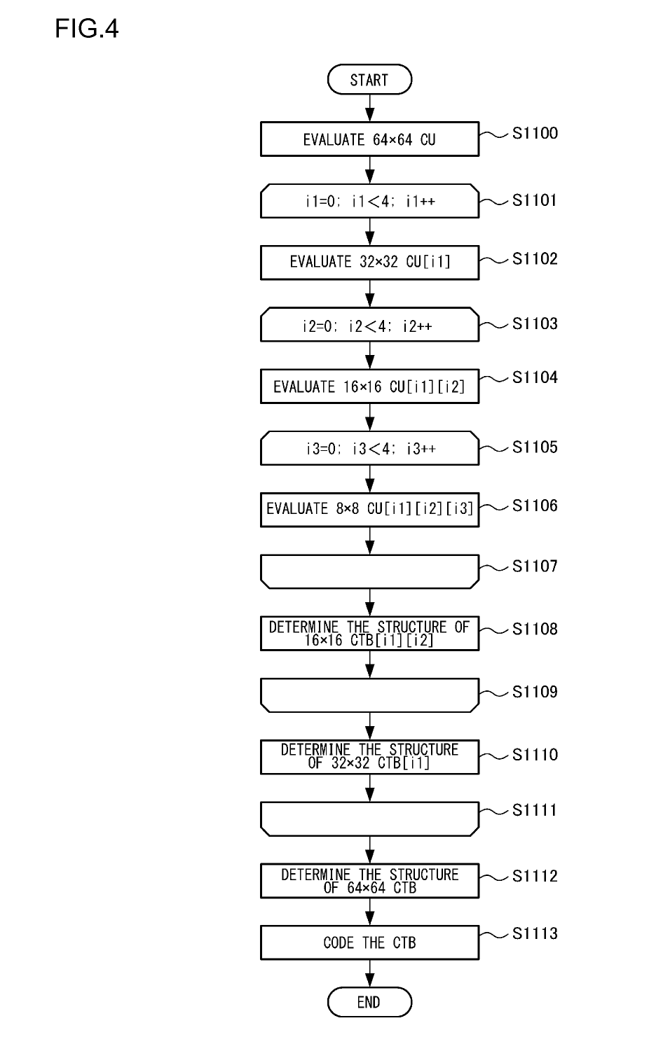

An operation of the LCTB bitstream generator 1001 is now described. FIG. 4 is a flowchart showing the operation of the LCTB bitstream generator 1001.

In the 64×64 CU evaluation unit 1100, a CU evaluation value of 64×64 CU is first computed (Step S1000).

Then, the following processing is repeatedly performed on 32×32 CU[i1] (i1=0, 1, 2, and 3), where four 32×32 CTBs generated by dividing 64×64 CTB are 32×32 CUs, (Step S1101). CU evaluation values of 32×32 CU[i1] are computed by the 32×32 CU evaluation unit 1101 (Step S1002).

Then, the following processing is repeatedly performed on 16×16 CU[i1][i2] (i2=0, 1, 2, and 3), where four 16×16 CTBs generated by dividing 32×32 CTB[i1] are 16×16 CUs, (Step S1003 to Step S1109). CU evaluation values of 16×16 CU[i1][i2] are computed by the 16×16 CU evaluation unit 1102 (Step S1004).

Then, the following processing is repeatedly performed on 8×8 CU[i1][i2][i3] (i3=0, 1, 2, and 3), where four 8×8 CTBs generated by dividing 16×16 CTB[i1][i2] are 8×8 CUs, (Step S1005 to Step S1107). CU evaluation values of 8×8 CU[i1][i2][i3] are computed by the 8×8 CU evaluation unit 1103 (Step S1006).

As the processing of four 8×8 CU[i1][i2][i3] is then completed (Step S1007), the 16×16 CTB mode determining unit 1104 determines whether the 16×16 CTB[i1][i2] (i2=0, 1, 2, and 3) are coded as a single 16×16 CU[i1][i2] or coded as four 8×8 CU[i1] [i2] [i3] (Step S1008). More specifically, the CU evaluation value of 16×16 CU[i1][i2], which is V_{—}16×16[i1][i2], is compared with the total value of CU evaluation values of four 8×8 CU[i1][i2][i3] (i3=1, 2, 3, and 3), which is V_{—}8×8[i1][i2]. And if V_{—}16×16[i1][i2] is smaller than or equal to V_{—}8×8[i1][i2], it will be determined that 16×16 CTB[i1][i2] are coded as a 16×16 CU[i1][i2]. Otherwise, it will be determined that the 16×16 CTB[i1][i2] are coded as four 8×8 CU[i1][i2][i3].

As the processing of four 16×16 CTB[i1][i2] is then completed (Step S1009), the 32×32 CTB mode determining unit 1105 determines whether the 32×32 CTB[i1] (i2=0, 1, 2, and 3) are coded as a single 32×32 CU[i1] or coded as four 16×16 CTB[i1][i2] (Step S1010). More specifically, the CU evaluation value of 32×32 CU[i1], which is V_{—}32×32[i1], is compared with the total value of CTB evaluation values of four 16×16 CTB[i1][i2] (i2=1, 2, 3, and 3), which is V_{—}16×16[i1]. And if V_{—}32×32[i1] is smaller than or equal to V_{—}16×16[i1], it will be determined that 32×32 CTB[i1] are coded as a 32×32 CU[i1]. Otherwise, it will be determined that the 32×32 CTB[i1] are coded as four 16×16 CTB[i1][i2].

As the processing of four 32×32 CTB[i1] is then completed (Step S1011), the 64×64 CTB mode determining unit 1106 determines whether the 64×64 CTB is coded as a single 64×64 CU or coded as four 32×32 CTB[i1] (Step S1012). More specifically, the CU evaluation value of 64×64 CU, which is V_{—}64×64, is compared with the total value of CTB evaluation values of four 32×32 CTB[i1] (i1=1, 2, 3, and 3), which is V_{—}32×32. And if V_{—}64×64 is smaller than or equal to V_{—}132×32, it will be determined that 64×64 CTB is coded as a 64×64 CU. Otherwise, it will be determined that the 64×64 CTB is coded as four 32×32 CTB[i1]. The CTB evaluation value differs from the CU evaluation value in that, in the CTB evaluation value, the amount of codes required for the division of CTB is added to the four CU evaluation values, which have been generated as a result of division of CTB, as the evaluation value.

The CTB coding is performed, based on the CTB structure that has been determined as above, at the CTB coding unit 1107 (Step S1013). In the CTB coding unit 1107, each CU is intra-coded or inter-coded based on the items of information on a coding mode, an inter mode, and an intra mode regarding each CU. Here, those items of information are supplied from the CU evaluation units by way of each CTB evaluation unit. In the intra coding, the processings of intra prediction, orthogonal transform, quantization and entropy coding are carried out and thereby a bitstream is generated according to a syntax. In the inter coding, the processings of inter prediction (motion compensation prediction), orthogonal transform, quantization and entropy coding are carried out and thereby a bitstream is generated according to a syntax. The orthogonal transform in the present embodiment is now described herein. In the advanced video coding (AVC), the block sizes for orthogonal transform are 4×4 and 8×8. In the orthogonal transform in the present embodiment, the available block sizes for orthogonal transform are 16×16 and 32×32 in addition to 4×4 and 8×8. The block size for orthogonal transform is specified in units of CU. A block-size information coding unit 1110, a coding mode coding unit 1111, an inter mode coding unit 1112 and a syntax will be described later.

A detailed description will be given later of the 64×64 CU evaluation unit 1100, the 32×32 CU evaluation unit 1101, the 16×16 CU evaluation unit 1102, the 8×8 CU evaluation unit 1103, the 16×16 CTB mode determining unit 1104, the 32×32 CTB mode determining unit 1105 and the 64×64 CTB mode determining unit 1106.

(Decoding Information Storage)

The decoding information storage 1002 stores the decoded picture data supplied from the LCTB bitstream generator 1001 and a predetermined number of pictures containing the motion information. It is assumed herein that, similar to AVC, the predetermined number of pictures is a predetermined number of pictures defined as a decoded picture buffer (DPB).

(Stream Multiplexing Unit)

The stream multiplexing unit 1003 multiplexes the bitstream, fed from the LCTB bitstream generator 1001, with a slice header, a picture parameter set (PPS), a sequence parameter set (SPS) and the like and thereby generates a multiplexed bitstream and then supplies the thus generated bitstream to the terminal 2. Here, the slice header defines a group of parameters used to determine the characteristics of a slice, PPS defines a group of parameters used to determine the characteristics of a picture, and SPS defines a group of parameters used to determine the characteristics of a bitstream. It is assumed herein that the size of maximum CTB and the size of minimum CTB are coded in SPS.

(CU Evaluation Unit)

A detailed description is given hereinbelow of the 64×64 CU evaluation unit 1100, the 32×32 CU evaluation unit 1101, the 16×16 CU evaluation unit 1102, and the 8×8 CU evaluation unit 1103. The basic structure of each of these component is the same and only the picture size to be processed differs for each thereof. Thus, the description thereof will be given collectively as a CTB evaluation unit.

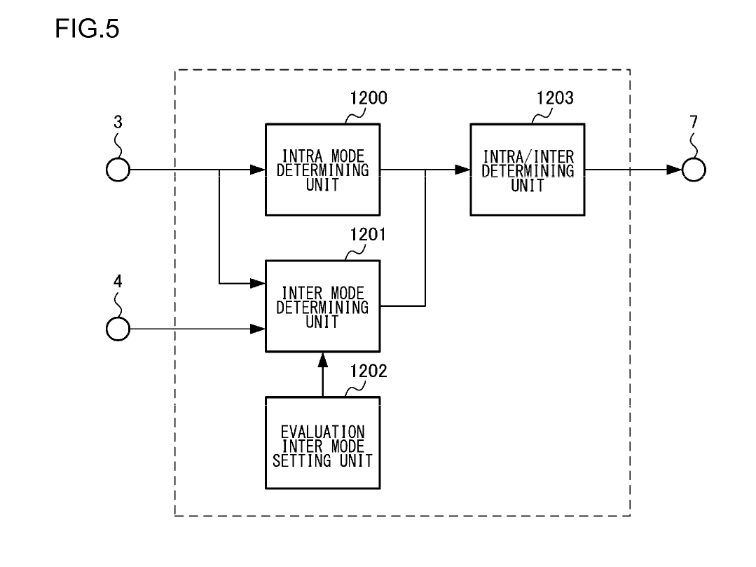

A structure of CTB evaluation unit is first described. FIG. 5 illustrates a structure of a CTB evaluation unit. It is to be noted here that the CTB evaluation unit of FIG. 5 is any one of the 64×64 CU evaluation unit 1100, the 32×32 CU evaluation unit 1101, the 16×16 CU evaluation unit 1102 and the 8×8 CU evaluation unit 1103 and that the 64×64 CU evaluation unit 1100, the 32×32 CU evaluation unit 1101, the 16×16 CU evaluation unit 1102 and the 8×8 CU evaluation unit 1103 are herein generically referred to as “CTB evaluation unit”. The CTB evaluation unit includes an intra mode determining unit 1200, an inter mode determining unit 1201, an evaluation inter mode setting unit 1202, and an intra/inter mode determining unit 1203. As for the 64×64 CU evaluation unit 1100, a terminal 7 is connected to the 64×64 CTB mode determining unit 1106. Similarly, as for the 32×32 CU evaluation unit 1101, the terminal 7 is connected to the 32×32 CTB mode determining unit 1105. As for the 16×16 CU evaluation unit 1102, the terminal 7 is connected to the 16×16 CTB mode determining unit 1104. As for the 8×8 CU evaluation unit 1103, the terminal 7 is connected to the 16×16 CTB mode determining unit 1104.

Then a description is given of an operation of the CTB evaluation unit and a function of each component thereof.

(Evaluation Inter Mode Setting Unit)

The evaluation inter mode setting unit 1202 first sets an inter mode usable in each CTB size (as well as each CU size) from among a plurality of predetermined inter modes (Step S1200). Then, the thus set usable inter mode is supplied to the inter mode determining unit 1201. A description will be given later of the plurality of predetermined inter modes and an inter mode usable in each CU size.

(Inter Mode Determining Unit)

Then, the inter mode determining unit 1201 acquires a picture signal of CTB to be processed from the picture signal of LCTB supplied through the terminal 3 (Step S1201), determines an inter mode, which is used when a picture signal of CTB to be processed, from among the usable inter modes (Step S1202), and computes an inter mode evaluation value about the determined inter mode by using a rate-distortion evaluation method. Then, the determined inter mode and the inter mode evaluation value are supplied to the intra/inter mode determining unit 1203.

In this case, the inter mode determining unit 1201 computes evaluation values about the usable inter modes, respectively, by using a rate-distortion evaluation method and selects an inter mode having the minimum evaluation value so as to determine the inter mode. A detailed description will be given later of the inter mode determining unit 1201.

(Rate-Distortion Evaluation Method)

A rate-distortion evaluation method is now described. An optimum solution is selected in a rate-distortion optimization (RDO) where a relation between the coding distortion amount and the amount of codes is optimized. A cost value used in a mode evaluation in RDO is shown in Equation (1).

cost=D+λ*R (Equation (1))

In Equation (1), λ is a constant that varies depending on a slice type and the like. A coding unit whose “cost” expressed by Equation (1) is minimum is selected as the optimum coding unit. Here, D (difference) in Equation (1) is evaluated based on the sum of squared difference (SSD) of an original picture and a decoded picture, and R in Equation (1) is the amount of codes required for the transmission of coefficients and motion information. However, R may not necessarily be measured by actually performing the entropy coding. Instead, an approximate amount of codes may be computed based on an easily estimated amount of codes. Also, D may not be obtained through SSD but may be obtained through the sum of absolute difference (SAD) instead.

(Intra Mode Determining Unit)

Then, the intra mode determining unit 1200 acquires a picture signal of CTB to be processed, from the picture signal of LCTB fed through the terminal 3 (Step S1204), determines an intra mode used when the picture signal of CTB to be processed is coded (Step S1205), and computes an intra mode evaluation value about the determined intra mode by using the rate-distortion evaluation method (Step S1206). Then, the determined intra mode and the intra mode evaluation value are supplied to the intra/inter mode determining unit 1203.

In this case, the intra mode determining unit 1200 computes evaluation values about a plurality of intra prediction modes and a PCM (Pulse-Code Modulation) mode, respectively, by using the rate-distortion evaluation method and selects an intra mode having the minimum evaluation value so as to determine the intra mode.

An intra mode is now described. The intra mode includes an intra prediction mode and a PCM mode. In the intra prediction mode utilizing an intra prediction technique, prediction pixels are generated using neighboring pixels similarly to the AVC, then a difference pixel of a prediction pixel and a picture signal is computed, and the difference pixel is coded by subjecting it to orthogonal transform and quantization. In the PCM mode, the picture signals are directly coded. Although there are a plurality of modes available for the intra prediction mode depending on how to use the neighboring pixels, the detailed description thereof is omitted here.

(Intra/Inter Mode Determining Unit)

Finally, the intra/inter mode determining unit 1203 checks to see if the inter mode evaluation value fed from the inter mode determining unit 1201 is smaller than or equal to the intra mode evaluation value fed from the intra mode determining unit 1200 (Step S1207). If the inter mode evaluation value is smaller than or equal to the intra mode evaluation value (YES of Step S1207), the coding mode that codes the picture signal of CTB to be processed will be set to the inter mode (Step S1208) and the inter mode evaluation value will be set as a CU evaluation value. Otherwise (NO of Step S1207), the coding mode that codes the picture signal of CTB to be processed will be set to the intra mode (Step S1209) and the intra mode evaluation value will be set as a CU evaluation value. Then the coding mode and the CU evaluation value are supplied to the terminal 7. Also, the inter mode is supplied to the terminal 7 if the coding mode is the inter mode, whereas the intra mode is supplied to the terminal 7 if the coding mode is the intra mode.

The evaluation values computed using the rate-distortion evaluation method is used in the aforementioned case. However, for example, a simpler operation, such as SAD (Sum of Absolute Difference) for each pixel, or SSE (Sum of Square Error) for each pixel with an offset value to be added, may be used in the detection of motion vectors.

(Inter Mode)

A description is now given of a plurality of predetermined inter modes. An inter mode is determined by a combination of a partition type and an inter prediction mode.

(Partition Type)

A partition type is first described.

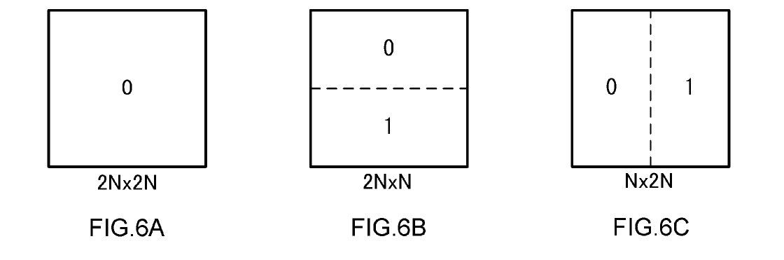

In the first embodiment, CU is further divided into partitions. CU is divided into one or two prediction blocks. FIGS. 6A to 6C illustrate partition types. FIG. 6A shows a 2N×2N where CU is composed of a single partition. FIG. 6B shows a 2N×N where CU is horizontally divided into two equal partitions. FIG. 6C shows a N×2N where CU is vertically divided into two equal partitions. “0” and “1” in FIGS. 6A to 6C indicate the partition numbers, and the partitions are processed in increasing number of partition number (i.e., “partition 0” and “partition 1” are processed in this order).

(Inter Prediction Mode)

An inter mode prediction is now explained below. The inter prediction mode includes a merge mode and a motion vector difference mode. As the motion compensation prediction, both the merge mode and the motion vector difference mode use a unidirectional motion compensation prediction, whose prediction direction is unidirectional, and a bidirectional motion compensation prediction, whose prediction direction is bidirectional. It is also assumed herein that, similar to the AVC, a prediction direction L0 and a prediction direction L1 are used and thereby a plurality of reference pictures are utilized. A motion compensation prediction, where a list of reference pictures along the prediction direction L0 is used and the prediction direction is unidirectional, is called an L0 prediction (Pred_L0). Similarly, a motion compensation prediction, where a list of reference pictures along the prediction direction L1 and the prediction direction is unidirectional, is called an L1 prediction (Pred_L1). Also, a motion compensation prediction, where the reference picture list of prediction diction L0 and the reference picture list of prediction direction L1 are both used and the prediction direction is bidirectional, is called a BI prediction (Pred_BI). The Pred_L0, Pred_L1, and Pred_BI, whose prediction directions in the motion compensation prediction, are defined to be of a inter prediction type.

The plurality of predetermined inter modes are determined by combining the above-described partition types and inter prediction modes. Also, as a result of such a combination, the inter mode is available in the following modes that are a 2N×2N merge mode, a 2N×N merge mode, an N×2N merge mode, a 2N×2N motion vector difference mode, a 2N×N motion vector difference mode, and an N×2N motion vector difference mode.

(Motion Information)

Motion information is now described below. The motion information is information used in the motion compensation prediction, and the motion information includes a reference picture index L0, which indicates reference pictures of prediction direction L0 in the reference picture list of prediction direction L0, a reference picture index L1, which indicates reference pictures of prediction direction L1 in the reference picture list of prediction direction L1, a motion vector mvL0 of prediction direction L0, and a motion vector mvL1 of prediction direction L1. The motion vectors mvL0 and mvL1 each contains a motion vector in the horizontal direction and a motion vector in the vertical direction. Assume in Pred_L0 that “−1” is assigned to the reference picture index L1 and a motion vector (0, 0) is assigned to mvL1. Also, assume in Pred_L1 that “−1” is assigned to the reference picture index L0 and a motion vector (0, 0) is assigned to mvL0. Also, assume that when the intra mode is selected as a coding mode of CU to be processed, “−1” is set to the reference picture index L0 and the reference picture index L1, and the motion vector (0, 0) is set to mvL0 and mvL1. Although the reference picture index having an invalid prediction direction is set to “−1”, this should not be considered as limiting and it may be set to any other value or set in any manner as long as it can be verified that the prediction diction in question is not valid.

(Merge Mode and Motion Vector Difference Mode)

A description is now given of a merge mode and a motion vector difference mode. In the merge mode, motion information is selected from a motion information candidate so as to carry out the motion compensation prediction. Here, the motion information candidate is generated based on neighboring motion information by using a predetermined method. In the motion vector difference mode, on the other hand, the motion compensation prediction is carried out by generating new motion information. Thus, the merge mode is generally useful if the transmission cost of the motion information is small and the correlation of motion with neighboring regions is high. Otherwise, the correlation of motion with the neighboring regions is relatively not high and prediction error can be transmitted at a reduced amount in spite of the increased transmission cost of the motion information, the motion vector difference mode will be useful. Note that if the prediction error cannot be transmitted at a reduced amount against the increased transmission cost of the motion information, the intra mode will be useful as the coding mode.

(Neighboring Partitions)

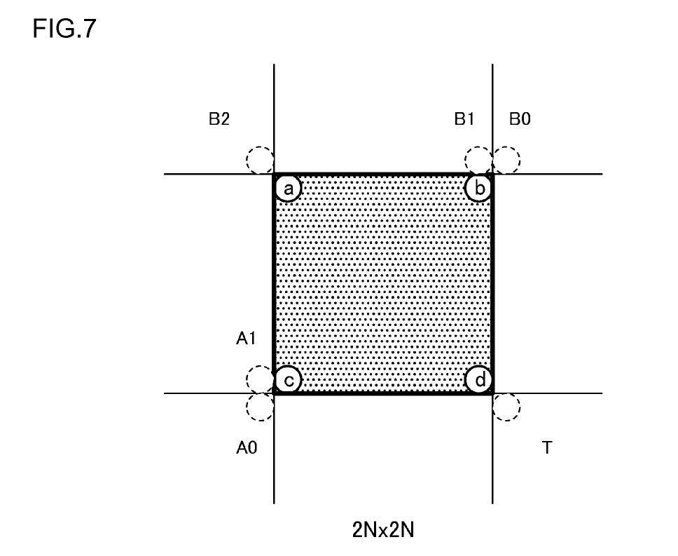

A description is now given of neighboring partitions used in the merge mode and the motion vector difference mode. FIG. 7 illustrates neighboring partitions. A description is given hereinbelow of neighboring partitions with reference to FIG. 7. Suppose that the neighboring partitions are coded or decoded partitions A0, A1, B0, B1, and B2, which neighbor a partition to be processed, and a partition T, which is a partition lying on a picture different from a picture on which the partition to be processed is located and which is adjacently located right below the partition to be processed. These neighboring partitions are determined relative to an upper-left pixel a, an upper-right pixel b, a lower-left pixel c, and a lower-right pixel d. A0 is a partition containing pixels located left below the lower-left pixel c of the partition to be processed. A1 is a partition containing pixels located to the left of the lower-left pixel c thereof. B0 is a partition containing pixels located right above the upper-right pixel b thereof. B1 is a partition containing pixels located above the upper-right pixel b thereof. B2 is a partition containing pixels located left above the upper-left pixel a thereof. T is a partition containing pixels located right below the lower-left right d thereof.

(Merge Candidate List and Merge Index)

In the merge mode, a merge candidate list, which includes five motion information candidates, is constructed based on the motion information on the neighboring partitions A0, A1, B0, B1, B2 and T. As for a method for constructing the merge candidate list, the same processing is carried out for the coding and the decoding, and the same merge candidate list is constructed in the coding and the decoding. In the coding, a single motion information candidate is selected from the merge candidate list and is coded as a merge index indicating the position of the selected motion information candidate in the merge candidate list. In the decoding, a motion information candidate is selected from the merge candidate list, based on the merge index. Thus, the same motion information candidate is selected in both the coding and the decoding. Though the number of motion information candidates included in the merge candidate list is five here, the number thereof may be arbitrary as long as it is one or greater.

(Motion Vector Predictor Candidate List and Motion Vector Predictor Index)

In the motion vector difference mode, a motion vector predictor candidate list L0, including two motion vector predictor candidates in the prediction direction L0, is constructed based on the motion information on the neighboring partitions A0, A1, B0, B1, B2 and T. In the case of a B slice (usable bidirectional prediction), a motion vector predictor candidate list L1, including two motion vector predictor candidates in the prediction direction L1, is further constructed. As for a method for constructing the motion vector predictor candidate list, the same processing is carried out for the coding and the decoding, and the same motion vector predictor candidate list is constructed in the coding and the decoding. In the coding, a single motion vector predictor candidate is selected from the motion vector predictor candidate list and is coded as a motion vector predictor index indicating the position of the selected motion vector predictor candidate in the motion vector predictor candidate list. In the decoding, a motion vector predictor candidate is selected from the motion vector predictor candidate list, based on the motion vector predictor index, so that the same motion vector predictor candidate is selected in both the coding and the decoding. Though the number of motion vector predictor candidates included in the motion vector predictor candidate list is two here, the number thereof may be arbitrary as long as it is one or greater. A motion vector difference, in which the selected motion vector predictor candidate has been subtracted from the motion vector, is coded in the coding. In the decoding, the selected motion vector predictor candidate and the motion vector difference are added up and thereby a motion vector is reproduced. Thus, the same motion vector is derived in both the coding and the decoding.

(Inter Mode Usable in Each CU Size)

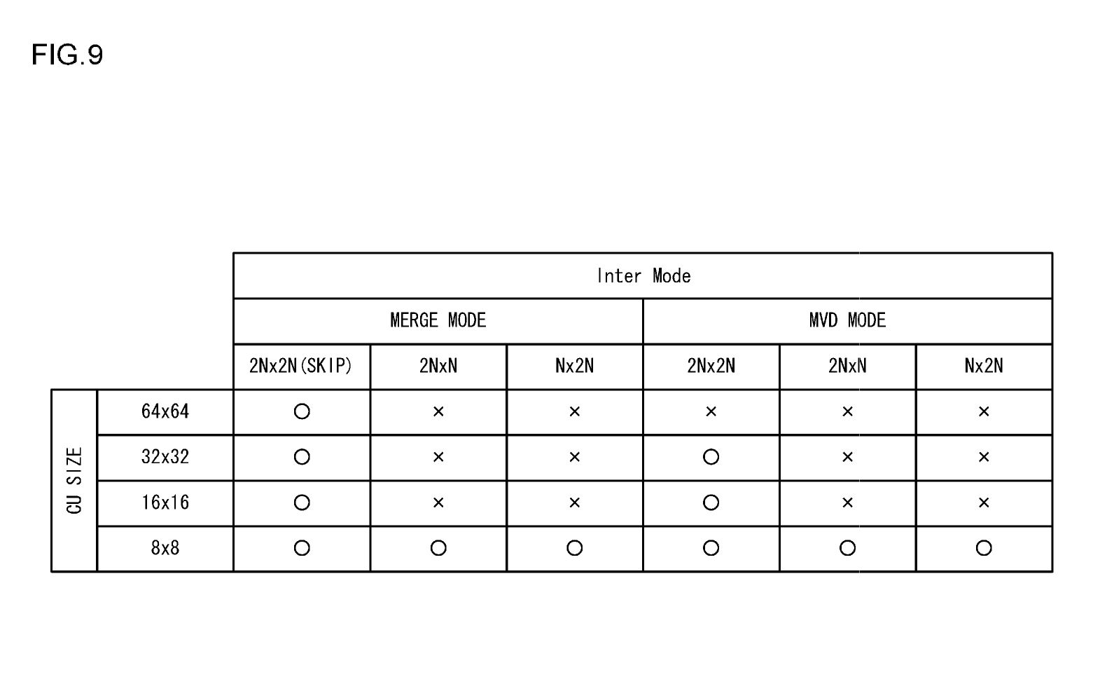

A description is now given of an inter mode usable in each CU size. FIG. 9 illustrates an inter mode or inter modes usable in each CU size. A description is given hereinbelow of “Inter Mode” usable in each “CU Size” with reference to FIG. 9. As shown in FIG. 9, a 2N×2N merge mode (“MERGE MODE” in FIG. 9) only is made usable in CU whose CU size is 64×64. For CU whose size is 32×32 and CU whose size is 16×16, a 2N×2N merge mode and a 2N×2N motion vector difference mode (“MVD MODE” in FIG. 9) are made usable. For CU whose size is 8×8, a 2N×2N merge mode, a 2N×N merge mode, an N×2N merge mode, a 2N×2N motion vector difference mode, a 2N×N motion vector difference mode, and an N×2N motion vector difference mode are made usable. A skip mode is explained here. The skip mode, which is a special case of the 2N×2N merge mode, is a mode where the motion information can be transmitted most efficiently. Though, in the aforementioned example, the 2N×2N merge mode, 2N×N merge mode, N×2N merge mode, 2N×2N motion vector difference mode, 2N×N motion vector difference mode, and N×2N motion vector difference mode are made usable in the CU whose size is 8×8, a new partition type may preferably be newly added in addition to the 2N×2N merge mode but this should not be considered as limiting. For example, a 2N×N merge mode and an N×2N merge mode may be added. Also, a 2N×N merge mode and an N×2N motion vector difference mode may be added.

(Effects of CU-Size Construction)

A description is given hereunder of advantageous effects achieved when the inter modes usable in each CU are set as described above. When, for general moving pictures, an inter mode is selected in a larger CU size, the spatial correlation between adjacent regions is higher. Also, first supplementary motion information, which is generated by combining the motion information of the prediction direction L0 and the prediction direction L1 in the motion information candidate obtained from adjacent partitions described later, is added to the merge candidate list of the present embodiment. Thus, a small movement shift or deviation can be corrected by a merge mode, for example. Also, second supplementary information indicating that motion vector described later is (0, 0) is added to the merge candidate list of the present embodiment, so that a movement partially containing a stationary part can be handled by the merge mode as well.

As the CU size becomes larger, the transmission cost of the prediction error becomes relatively larger than that of the motion information. Accordingly, an increase in the cost, caused by the division of CU when CU having a second largest CU size is generated by dividing CU having the maximum CU size, and cost of the motion information are relatively minimum as compared with the increases in the cost, caused when CUs of other CU sizes are divided, and the cost of the motion information. Also, the maximum size of orthogonal transform usable in CU having the maximum CU size is equal to the maximum size thereof usable in CU having the second largest CU size, so that there is no difference in transform efficiency between CU having the maximum CU size and CU having the second largest CU size.

Since, in the motion vector difference mode, the motion compensation prediction is performed by generating new motion information, a motion detection is generally made. It is known, however, that the motion detection processing involves an extremely large amount of computation in the coding processing. On the other hand, no motion detection is required in the merge mode and therefore the processing amount is relatively very small than that in the motion vector difference mode.

As described above, in CU having the maximum CU size, the only 2N×2N merge mode combined with the skip mode is evaluated, so that the drop in the coding efficiency can be suppressed to the minimum while the processing amount is much suppressed.

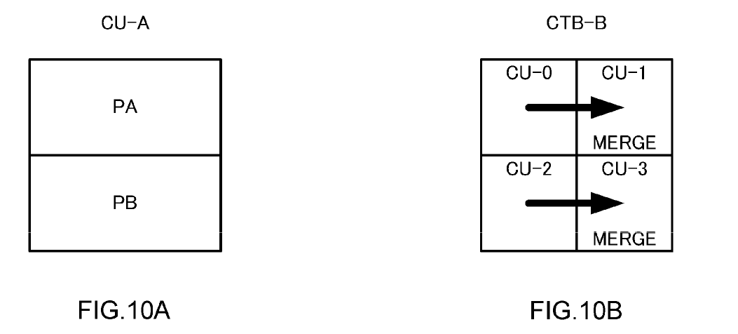

The partition types of 2N×N and N×2N for CU having a CU size other than the minimum CU size can be achieved if the motion information on two CUs obtained after the CU has been divided as CTB is made the same. FIGS. 10A and 10B illustrate CTB having the same motion information as the partition type of 2N×N. The partition type of CU-A is 2N×N, and CU-A is composed of a partition A (PA) and a partition B (PB). CTB-B, which has been divided with CU-A as CTB, is composed of four CUs (CU-0, CU-1, CU-2, and CU-3) each of partitions, namely the four CUs, is 2N×2N. In this case, the motion information on CU-0 is regarded identical to that on PA by the motion vector difference mode or merge mode. Similarly, the motion information on CU-2 is regarded identical to that on PB by the motion vector difference mode or merge mode. Also, CU-1 is set to the merge mode, and the motion information on the CU-0 is utilized. Also, CU-3 is set to the merge mode, and the motion information on the CU-2 is utilized. Thereby, the motion information on CU-0 and CU-1 can be set identical to the motion information on CU-A and the motion information on CU-2 and CU-3 can be set identical to the motion information on CU-B each other. Thus, provision of the motion vector difference mode, in which the motion information can be specified anew, and the merge mode, in which the transmission cost of the motion information is low, can minimally suppress the cost by which to achieve the partition types of 2N×N and N×2N by dividing CU as CTB. Here, the cost by which to achieve the partition types of 2N×N and N×2N by dividing CU as CTB corresponds to the transmission cost for the division of CTB and the transmission cost of two merge modes. Also, it is possible to reduce the overlapping degree of evaluation processes where the motion information on the partition types of 2N×N and N×2N for CU having the CU size other than the minimum CU size is made the same and where the motion information on two CUs obtained after the CU has been divided as CTB is made the same.

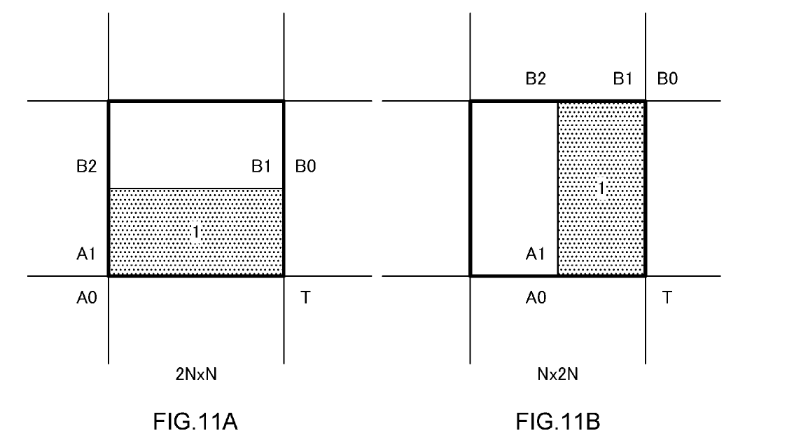

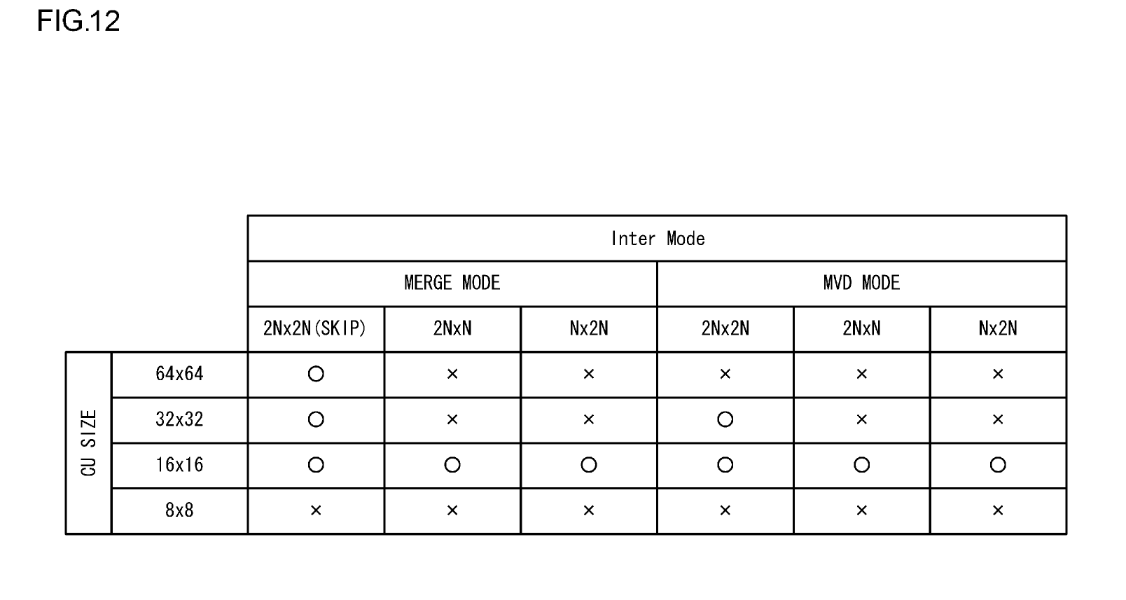

There are many invalid candidates in the merge mode of partitions whose partition types are 2N×N and N×2N. FIGS. 11A and 11B illustrate neighboring partitions whose partition types are 2N×N and N×2N, respectively. FIG. 11A shows neighboring partitions of the 2N×N partition 1. In this case, a neighboring partition B1 is disabled when the merge candidate list is constructed. Also, a neighboring partition B0 is not yet coded or decoded and therefore not counted as a neighboring partition. FIG. 12A shows neighboring partitions of the N×2N partition 1. In this case, a neighboring partition A1 is disabled when the merge candidate list is constructed. Also, a neighboring partition A0 is not yet coded or decoded and therefore not counted as a neighboring partition. Accordingly, the number of motion information candidates derived from the neighboring partitions of the 2N×N or N×2N partition is three at most and it is therefore difficult to enhance the coding efficiency as compared to the 2N×N or N×2N partition 0 and 2N×2N.

As described above, the partition types of 2N×N and N×2N are not used for CUs except for CU having the minimum CU size, so that the drop in the coding efficiency can be suppressed to the minimum while the processing amount is much suppressed.

Also, the partition types of 2N×N and N×2N are used for CU having the minimum CU size and thereby the coding efficiency for moving pictures moving in a subtle manner or the like can be enhanced.

A description was made, in conjunction with FIG. 9, on the assumption that CU, whose CU size is 8×8, is used. However, where a picture is of a large size such as 4K2K (3840×2160) or 8K4K (7680×4320), use of a small CU size may break the balance between the processing amount and the coding efficiency, as compared to the balance therebetween achieved in the case of a high-definition television size (1920×1080). Thus, the inter mode usable in each CU size may be switched depending on the picture size. FIG. 12 illustrates another exemplary inter mode(s) usable in each CU size. The appropriate inter mode(s) or no inter mode may be invoked as follows, for example. That is, if, for example, the picture size is smaller or equal to the high-definition television (HDTV) size, the inter mode as shown in FIG. 9 will be used; if the picture size is larger than the HDTV size, the inter mode as shown in FIG. 12 may be used.

(Inter Mode Determining Unit)

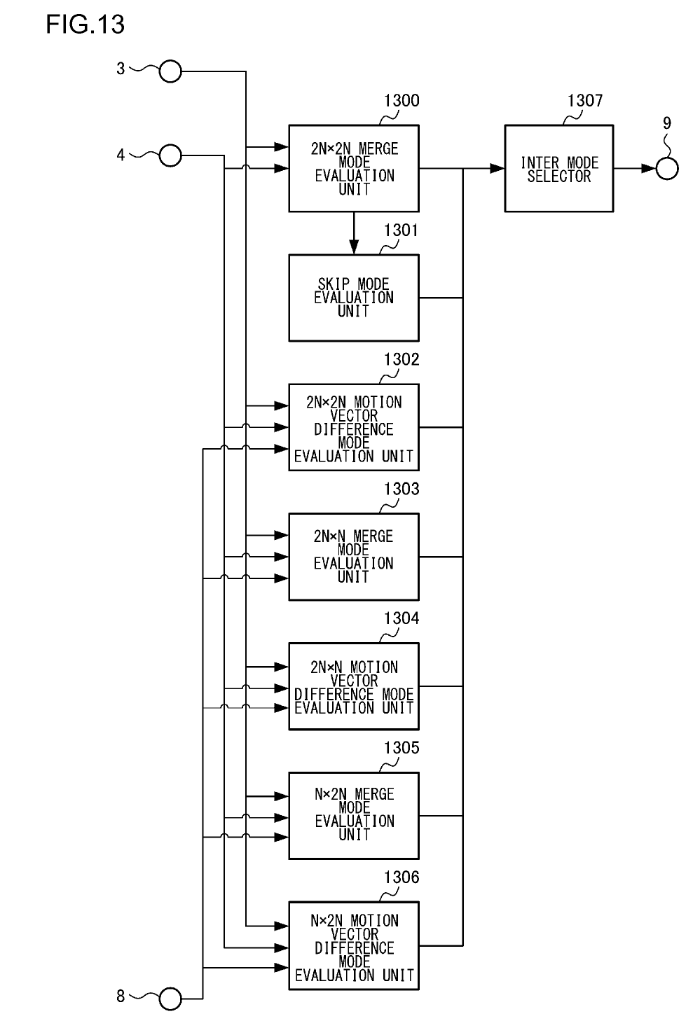

The inter mode determining unit 1201 is now described in detail. FIG. 13 illustrates a structure of the inter mode determining unit 1201. A description is given hereinbelow of the inter mode determining unit 1201 with reference to FIG. 13. The inter mode determining unit 1201 includes a 2N×2N merge mode evaluation unit 1300, a skip mode evaluation unit 1301, a 2N×2N motion vector difference mode evaluation unit 1302, a 2N×N merge mode evaluation unit 1303, a 2N×N motion vector difference mode evaluation unit 1304, an N×2N merge mode evaluation unit 1305, an N×2N motion vector difference mode evaluation unit 1306, and an inter mode selector 1307. A terminal 8 is connected to the evaluation inter mode setting unit 1202. A terminal 9 is connected to the intra/inter mode determining unit 1203.

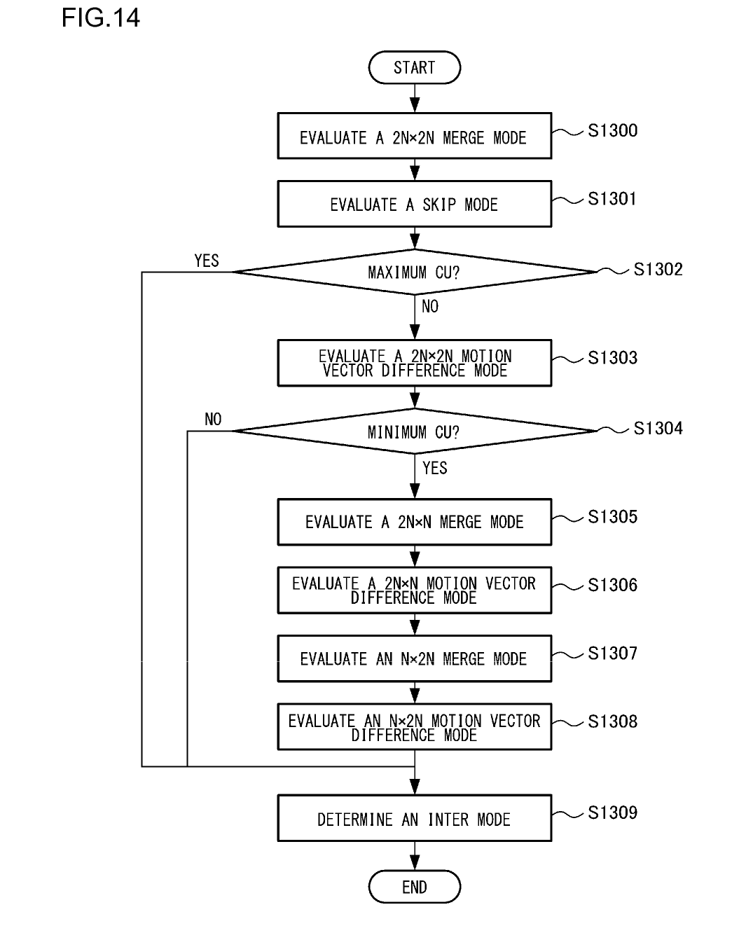

Then a description is given of an operation of the inter mode determining unit 1201 and a function of each component thereof. FIG. 14 is a flowchart showing an operation of the inter mode determining unit 1201.

The 2N×2N merge mode is first evaluated at the 2N×2N merge mode evaluation unit 1300 (Step S1300). Then, the evaluation value of the 2N×2N merge mode and the merge index are supplied to the inter mode selector 1307. Also, the merge index is supplied to the skip mode evaluation unit 1301.

Then, the evaluation value of the skip mode is computed at the skip mode evaluation unit 1301 (Step S1301). The skip mode evaluation unit 1301 checks to see if the merge index selected as the 2N×2N merge mode meets a skip mode condition. The skip mode condition is that the orthogonal transform coefficient to be coded is 0. If the skip mode condition is met, the evaluation value will be computed, as the skip mode, by using the rate-distortion evaluation method. If the skip mode is not met, the evaluation value will be set to a maximum value so that the skip mode is not selected. Then, the evaluation value of the skip mode is supplied to the inter mode selector 1307.

Then, whether or not CU is of the maximum size is checked (Step S1302).

If CU is of the maximum size (YES of Step S1302), an inter mode will be determined at the inter mode selector 1307 (Step S1309). Here, the evaluation value of the 2N×2N merge mode or the evaluation value of the skip mode, whichever is smaller, is selected as the inter mode.

If CU is not of the maximum size (NO of Step S1302), the 2N×2N motion vector difference mode is evaluated at the 2N×2N motion vector difference mode evaluation unit 1302 (Step S1303). Then, the evaluation value of the 2N×2N motion vector difference mode, the reference picture index, the motion vector difference, and the motion vector predictor candidate index are supplied to the inter mode selector 1307.

Then, whether or not CU is of the minimum size is checked (Step S1304). If CU is not of the minimum size (NO of Step S1304), an inter mode will be determined at the inter mode selector 1307 (Step S1309). Here, the respective evaluation values of the skip mode, the 2N×2N merge mode, and the 2N×2N motion vector difference mode are compared with each other and then a mode having the minimum value among those evaluation values thereof is selected as the inter mode.

If CU is of the minimum size (YES of Step S1304), the 2N×N merge mode is evaluated at the 2N×N merge mode evaluation unit 1303 (Step S1305). Then, the evaluation value of the 2N×N merge mode and the merge index are supplied to the inter mode selector 1307.

Then, the 2N×N motion vector difference mode is evaluated at the 2N×N motion vector difference mode evaluation unit 1304 (Step S1306). Then, the evaluation value of the 2N×N motion vector difference mode, the reference picture index, the motion vector difference, and the motion vector predictor candidate index are supplied to the inter mode selector 1307.

Then, the N×2N merge mode is evaluated at the N×2N merge mode evaluation unit 1305 (Step S1307). Then, the evaluation value of the N×2N merge mode and the merge index are supplied to the inter mode selector 1307.

Then, the N×2N motion vector difference mode is evaluated at the N×2N motion vector difference mode evaluation unit 1306 (Step S1307). Then, the evaluation value of the N×2N motion vector difference mode, the reference picture index, the motion vector difference, and the motion vector predictor candidate index are supplied to the inter mode selector 1307.

Then, an inter mode is determined at the inter mode selector 1307 (Step S1309). Here, the respective evaluation values of the skip mode, the 2N×2N merge mode, the 2N×2N motion vector difference mode, the 2N×N merge mode, the 2N×N motion vector difference mode, the N×2N merge mode, and the N×2N motion vector difference mode are compared with each other and then a mode having the minimum value among those evaluation values thereof is selected as the inter mode.

(Merge Mode Evaluation Unit)

The merge mode evaluation units are now described in detail. Each merge mode evaluation unit shares the same feature except that the partition type differs in each of the 2N×2N merge mode evaluation unit 1300, the 2N×N merge mode evaluation unit 1303, and the N×2N merge mode evaluation unit 1305.

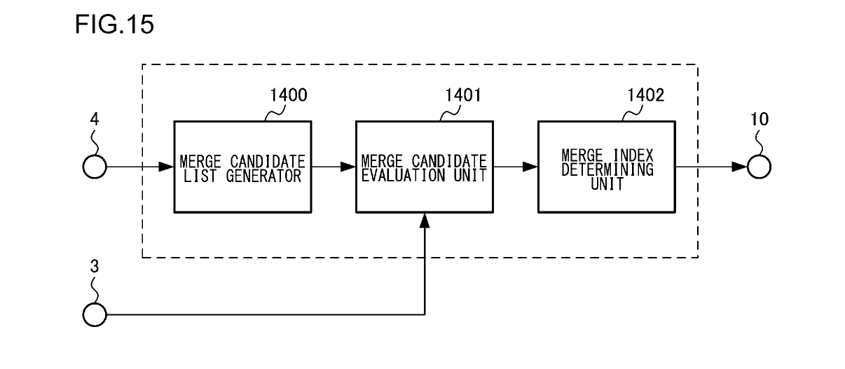

FIG. 15 illustrates a merge mode evaluation unit. The merge mode evaluation unit is comprised of a merge candidate list constructing unit 1400, a merge candidate evaluation unit 1401, and a merge index determining unit 1402. A terminal 10 is connected to the inter mode selector 1307.

Then a description is given of an operation of the merge mode evaluation unit and a function of each component thereof. The merge candidate list constructing unit 1400 first constructs a merge candidate list based on the motion information, regarding the neighboring partitions, supplied through the terminal 4. Then the merge candidate list is supplied to the merge candidate evaluation unit 1401. Then the merge candidate evaluation unit 1401 computes evaluation values about the motion information on all the motion information candidates included in the merge candidate list supplied from the merge candidate list constructing unit 1400, based on the picture signals supplied through the terminal 3 by using the rate-distortion evaluation method. Then the evaluation values of all the motion information candidates included in the merge candidate list are supplied to the merge index determining unit 1402. The merge index determining unit 1402 selects motion information having the minimum evaluation value as the motion information of the merge mode, from among the evaluation values supplied from the merge candidate evaluation unit 1401, and then determines a merge index. Then the merge index and the selected evaluation value are supplied to the terminal 10.

(Merge Candidate List Constructing Unit)

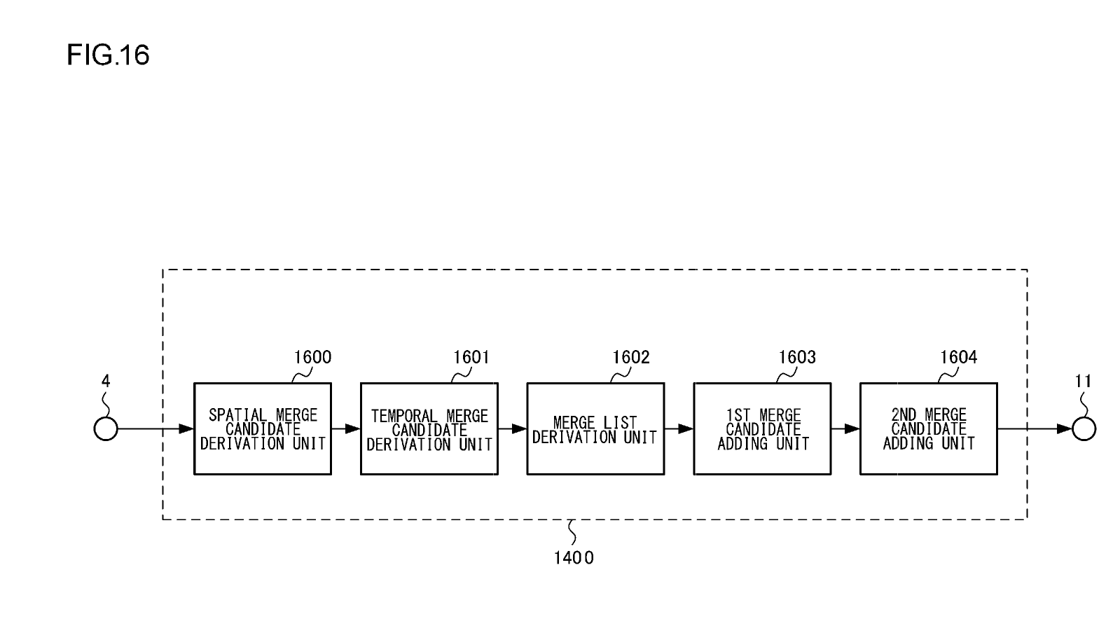

A description is now given of the merge candidate list constructing unit 1400. FIG. 16 illustrates a structure of the merge candidate list constructing unit 1400. A description is given hereinbelow of the merge candidate list constructing unit 1400 with reference to FIG. 16. The merge candidate list constructing unit 1400 includes a spatial merge candidate derivation unit 1600, a temporal merge candidate derivation unit 1601, a merge list constructing unit 1602, a first merge candidate adding unit 1603, and a second merge candidate adding unit 1604. A terminal 11 is connected to the merge candidate evaluation unit 1401.

An operation of the merge candidate list constructing unit 1400 is explained hereinbelow. The spatial merge candidate derivation unit 1600 checks whether the motion information on the neighboring partitions A1, B1, B0, A1 and B2 is invalid or not, in this order. Here, “motion information on a neighboring partition being invalid” corresponds to the following (1) to (4):

(1) The neighboring partition is located outside a picture region.
(2) The coding mode of the neighboring partition is an intra mode.
(3) The partition type is a 2N×N partition 1, and the neighboring partition is B1.
(4) The partition type is an N×2N partition 1, and the neighboring partition is A1.

And the spatial merge candidates are the motion information on at most four valid neighboring partitions. Then the temporal merge candidate derivation unit 1601 checks whether the motion information on the neighboring partition T is valid or not. If it is valid, the motion information on the neighboring partition T will be selected as a temporal merge candidate. Then the merge list constructing unit 1602 constructs a merge candidate list from the spatial merge candidates and the temporal merge candidates. Then the merge candidate list constructing unit 1400 checks whether the number of motion information candidates in the merge candidate list is five or not. If the number thereof is five, the construction of the merge candidate list will be terminated. If the number thereof is not five, the subsequent construction of the merge candidate list will continue. At this time, if the partition is included in a B slice and if the number of motion information candidates in the merge candidate list is greater than or equal to two, the first merge candidate adding unit 1603 will generate new first supplementary motion information, used for a bi-prediction, by combining Pred_L0, which is a first motion information candidate in the merge candidate list, with Pred_L1, which is a second motion information candidate in the merge candidate list, and add the thus generated first supplementary information to the merge candidate list as a merge candidate. If a first motion information candidate and a second motion information candidate are other motion candidates in the merge candidate list, the first supplementary motion information will be generated and added until the number of motion information candidates in the merge candidate list reaches five. Then, the second merge candidate adding unit 1604 generates the second supplementary motion information having the motion vector (0, 0) until the number of motion information candidates in the merge candidate list becomes five, and adds the thus generated second supplementary motion information to the merge candidate list as a merge candidate.

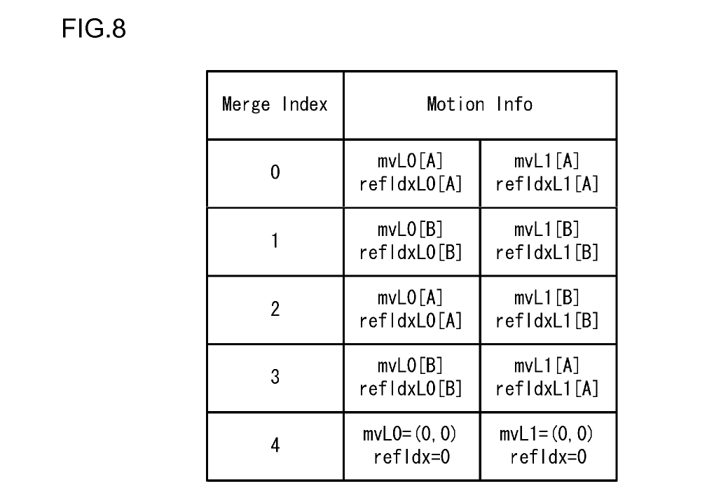

The merge candidate list is described herein. FIG. 8 illustrates an exemplary merge candidate list. In the merge candidate list shown in FIG. 8, two items of motion information (“Motion Info” in FIG. 8) indicated by merge indices 0 and 1 (“Merge Index 0 and Merge Index 1” in FIG. 8) are the motion information on a neighboring partition. Motion information indicated by merge indices 2 and 3 is the first supplementary motion information. The first supplementary motion information in the merge index 2 is generated such that the motion information of prediction direction L0 in the merge index 0 is combined with the motion information of prediction direction L1 in the merge index 1. The first supplementary motion information in the merge index 3 is generated such that the motion information of prediction direction L0 in the merge index 1 is combined with the motion information of prediction direction L1 in the merge index 0. The motion information in the merge index 4 is the second supplementary motion information.

(Motion Vector Difference Mode Evaluation Unit)

A motion vector difference mode evaluation is now described in detail. Each motion vector difference mode evaluation unit shares the same feature except that the partition type differs in each of the 2N×2N motion vector difference mode evaluation unit 1302, the 2N×N motion vector difference mode evaluation unit 1304, and the N×2N motion vector difference mode evaluation unit 1306.

A motion vector contained in Pred_L0 is first detected. In the detection of the motion vector contained therein, an evaluation value is computed, based on an estimated amount of codes for the prediction error, the reference picture index, the motion vector difference, and the motion vector predictor candidate index relative to a reference picture contained in the reference picture list L0 of Pred_L0. And a combination of a motion vector difference mvdL0, a motion vector predictor candidate index mvpL0 and a reference picture index refIdxL0 where the evaluation value becomes minimum is determined. Here, the evaluation value in the motion vector detection is computed using the same rate-distortion evaluation method as that used in the merge mode evaluation units. It is understood that any other rate distortion algorithms may be used as long as the final evaluation value is identical to that obtained by the merge mode evaluation units. For example, a rate-distortion evaluation value for the determined motion vector may be computed by using a simpler operation, such as per-pixel SAD (Sum of Absolute Difference), per-pixel SSE (Sum of Square Error) or the like in the detection of motion vectors. If the partition is P (Predictive) slice, Pred_L0 is selected as an inter prediction mode in the 2N×2N motion vector difference mode. Note that the motion vector is derived in a manner such that a motion vector predictor, in the motion vector predictor candidate list indicated by the motion vector predictor candidate index, and a motion vector difference are added up.

If the partition is included in a B slice, a combination of a motion vector difference mvdL1, a motion vector predictor candidate index mvpL1 and a reference picture index refIdxL1 will be determined and an evaluation value will be obtained for Pred_L1 in a similar manner. Also, as for Pred_BI, an evaluation value is computed by combining mvL0, mvpL0, refIdxL0, mvL1, mvpL1, and refIdxL1. Then an inter prediction mode where the evaluation value becomes minimum is selected, as the 2N×2N motion vector difference mode, from among Pred_L0, Pred_L1, and Pred_BI.

(Syntax)

A part of syntax used in the present embodiment is now described. A syntax is used in the coding and the decoding. In the coding, a syntax element is transformed into a bitstream according to the syntax. In the decoding, the bitstream is decoded to the syntax element. Thus, a common rule for the coding and the decoding is established, so that the syntax element intended by the coding can be reproduced in the decoding. The coding and the decoding of syntax elements are done by using an entropy coding and an entropy decoding, and are carried out by using a method including a variable-length coding such as arithmetic coding and Huffman coding.

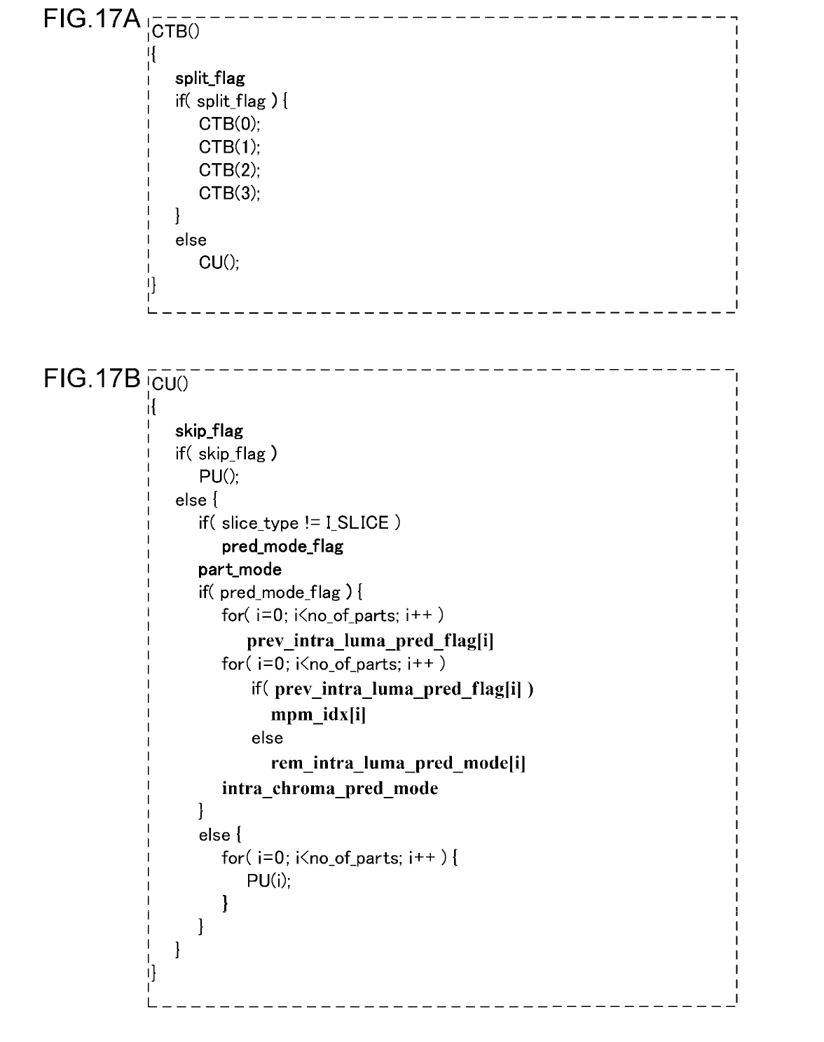

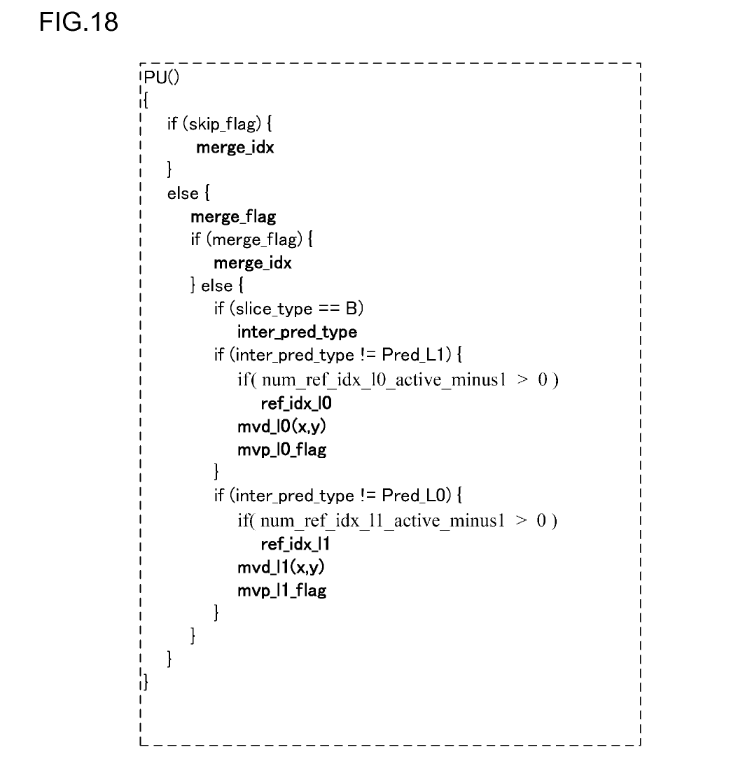

FIGS. 17A and 17B and FIG. 18 are diagrams to explain a syntax. A description is given hereinbelow of the syntax with reference to FIGS. 17A and 17B and FIG. 18. FIG. 17A shows a structure of CTB. CTB includes split_flag, which is a split flag required according to the number of divisions. If split_flag is “1”, the CTB will be divided into four CTBs; if split_flag is not “1”, the CTB will become CU. “split_flag” is a bit of “0” or “1”.

FIG. 17B shows a structure of CU. CU contains skip_flag (skip flag). If skip_flag is “1”, CU contains a single prediction unit (PU). If the skip flag is not “1”, pred_mode_flag, which indicates a coding mode, and part_mode, which indicates a partition type, are contained in CU. If pred_mode_flag is “1”, information regarding an intra mode (e.g., mpm_idx) will be contained in CU. If pred_mode_flag is not “1”, PUs the number of which corresponds to the partition type will be contained. “skip_flag” and “pred_mode_flag” are each a bit of “0” or “1”. In “part_mode”, truncated unary bitstrings are assigned such that “0” indicates “2N×2N”, “1” indicates “2N×2”, and “2” indicates “N×2N”.

FIG. 18 illustrates a structure of PU. If skip_flag is “1”, PU will contain merge_idx only. If skip_flag is not “1”, PU will contain merge_flag (merge flag), which is a flag indicating that the inter prediction mode is a merge mode. If merge_flag is “1”, merge_idx will be contained in PU. If merge_flag is not “1”, inter_pred_type, which is an inter prediction type, will be contained. If inter_pred_type is not Pred_L1, PU will further contain ref_idx_l0, which is a reference picture index L0, mvd_l0(x, y), which is a motion vector difference of prediction direction L0, and mvp_l0 flag, which is a motion vector predictor flag of prediction direction L0. If inter_pred_type is not Pred_L0, PU will further contain ref_idx_l1, which is a reference picture index L1, mvd_l1(x, y), which is a motion vector difference of prediction direction L1, and mvp_l1_flag, which is a motion vector predictor flag of prediction direction L1. “merge_flag”, “mvp_l0_flag” and “mvp_l1_flag” are each a bit of “0” or “1”. Truncated unary bitstrings are assigned to “merge_idx”, “ref_idx_l0” and “ref_idx_l1”. In “inter_pred_type”, truncated unary bitstrings are assigned such that “0” indicates “Pred_BI”, “1” indicates “Pred_L0”, and “2” indicates “Pred_L1”.

The syntaxes related to the merge modes are skip_flag, merge_flag, and merge_idx. On the other hand, the syntaxes related to the motion vector differenced are skip_flag, merge_flag, inter_pred_type, ref_idx_l0, mvd_l0(x, y), mvp_l0_flag, ref_idx_l1, mvd_l1(x, y), and mvp_l1 flag.

(Block-Size Information Coding Unit)

The block-size information coding unit 1110 codes split_flag and a partition type according to each syntax.

(Coding Mode Coding Unit)

The coding mode coding unit 1111 codes pred_mode_flag according to each syntax.

(Inter Mode Coding Unit)

The inter mode coding unit 1112 codes skip_flag, merge_flag, merge_idx, inter_pred_type, ref_idx_l0, mvd_l0(x, y), mvp_l0 flag, ref_idx_l1, mvd_l1(x, y), and mvp_l1_flag according to each syntax.

(Structure of Moving Picture Decoding Apparatus 200)

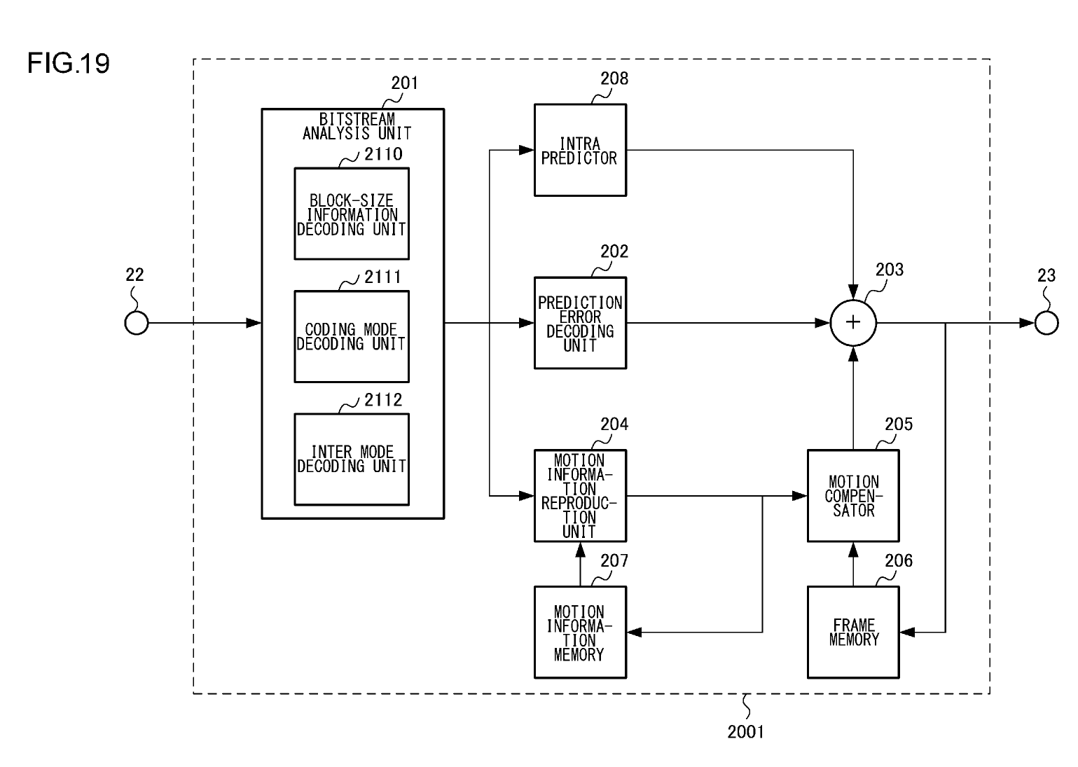

A description is now given of a moving picture decoding apparatus according to the first embodiment. FIG. 19 illustrates a structure of a moving picture decoding apparatus 200 according to the first embodiment. The moving picture decoding apparatus 200 decodes the bitstreams coded by the moving picture coding apparatus 100 and generates reproduced pictures.

The moving picture decoding apparatus 200 is implemented hardware by an information processing apparatus comprised of a CPU (Central Processing Unit), a frame memory, a hard disk and so forth. The aforementioned components of the moving picture decoding apparatus 200 operate to achieve the functional components described hereunder.

The moving picture decoding apparatus 200 according to the first embodiment includes a bitstream analysis unit 201, a prediction error decoding unit 202, an adder 203, a motion information reproduction unit 204, a motion compensator 205, a frame memory 206, a motion information memory 207, and an intra predictor 208.

(Operation of Moving Picture Decoding Apparatus 200)

A description is given hereunder of a function and an operation of each component of the moving picture decoding apparatus 200. The bitstream analysis unit 201 analyzes the bitstreams fed through a terminal 30 and entropy-decodes the following items of information according to each syntax. Here, those items of information to be entropy-decoded by the moving picture decoding apparatus 200 are a split flag, a skip flag, a coding mode, a partition type, information regarding an intra mode, a merge flag, a merge index, an inter prediction type, a reference picture index, a motion vector difference, a motion vector predictor index, a prediction error coding data, and so forth. Then, the size of each partition is derived from the split flag and the partition type. Then, the prediction error coding data is supplied to the prediction error decoding unit 202; the merge flag, the merge index, the inter prediction type, the reference picture index, the motion vector difference, and the motion vector predictor index are supplied to the motion information reproduction unit 204; the information on the intra mode is supplied to the intra predictor 208. A detailed structure of the bitstream analysis unit 201 will be described later.

Also, the bitstream analysis unit 201 decodes the syntax elements contained in SPS, PPS and the slice header, as necessary, from the bitstreams. Note that the maximum size of CTB and the minimum size of CTB are decoded from SPS.

The motion information reproduction unit 204 reproduces the motion information on partitions to be processed and then supplied the thus reproduced motion information to the motion compensator 205 and the motion information memory 207. Here, the motion information on partitions to be processed are reproduced thereby from the merge flag, the merge index, the inter prediction type, the reference picture index, the motion vector difference and the motion vector predictor index, which are all supplied from the bitstream analysis unit 201, and from the motion information, on the neighboring partitions, supplied from the motion information memory 207. A detailed structure of the motion information reproduction unit 204 will be described later.

The motion compensator 205 motion-compensates a reference picture indicated by the reference picture index in the frame memory 206, based on the motion information supplied from the motion information reproduction unit 204, and thereby generates a prediction signal. If the inter prediction type is Pred_BI, the motion compensator 205 will compute an average of the prediction signal of L0 prediction and the prediction signal of L1 prediction and then generates the averaged signal as the prediction signal. Then the thus generated prediction signal is supplied to the adder 203. The derivation of the motion vector will be described later.

The intra predictor 208 generates a prediction signal, based on the information regarding the intra mode supplied from the bitstream analysis unit 201. Then the thus generated prediction signal is supplied to the adder 203.

The prediction error decoding unit 202 performs processings, such as inverse quantization and inverse orthogonal transform, on the prediction error coding data supplied from the bitstream analysis unit 201, thereby generates a prediction error signal and then supplied the prediction error signal to the adder 203.

The adder 203 adds up the prediction error signal fed from the prediction error decoding unit 202 and the prediction signal fed from the motion compensator 205 or the intra predictor 208, thereby generates a decoded picture signal and then supplies the decoded picture signal to the frame memory 206 and a terminal 31.

The frame memory 206 stores the decoded picture signal supplied from the adder 203. The motion information memory 207 stores the motion information, supplied from the motion information reproduction unit 204, in units of the minimum prediction block size.

(Detailed Structure of Bitstream Analysis Unit)

The bitstream analysis unit 201 includes a block-size information decoding unit 2110, a coding mode decoding unit 2111, and an inter mode decoding unit 2112.

(Block-Size Information Decoding Unit)

The block-size information decoding unit 2110 decodes split_flag and the partition type according to each syntax.

(Coding Mode Decoding Unit)

The coding mode decoding unit 2111 decodes pred_mode_flag according to a syntax.

(Inter Mode Decoding Unit)

The inter mode decoding unit 2112 decodes skip_flag, merge_flag, merge_idx, inter_pred_type, ref_idx_l0, mvd_l0(x, y), mvp_l0 flag, ref_idx_l1, mvd_l1(x, y), and mvp_l1_flag according to each syntax.

(Detailed Structure of Motion Information Reproduction Unit 204)

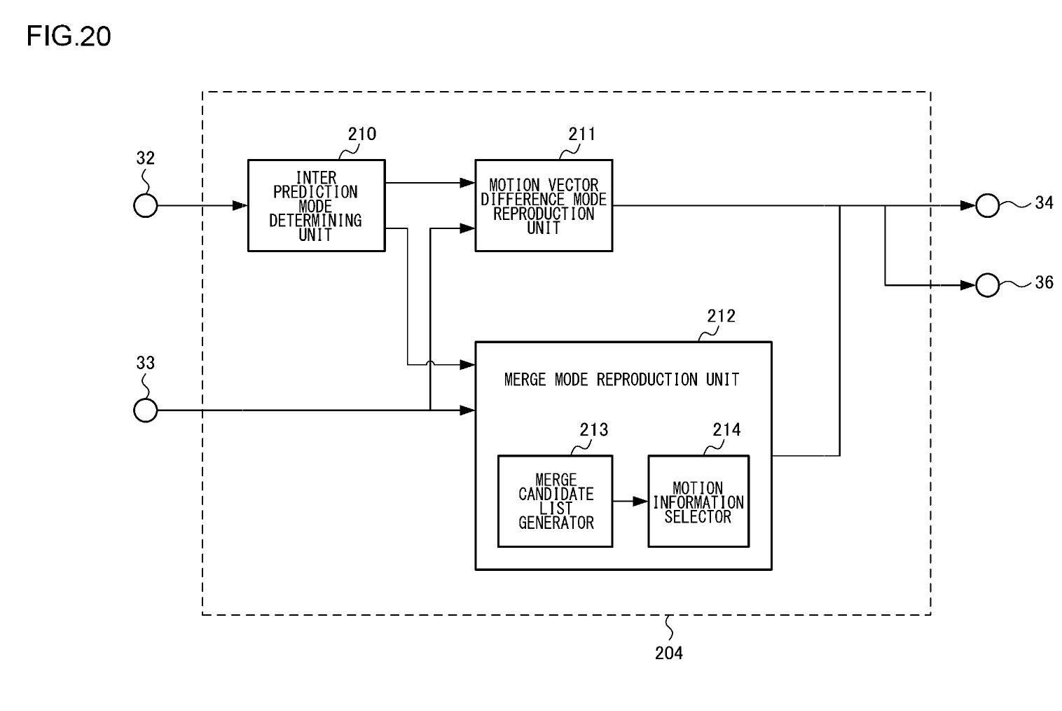

A detailed structure of the motion information reproduction unit 204 is now described. FIG. 20 illustrates a structure of the motion information reproduction unit 204. The motion information reproduction unit 204 includes an inter prediction mode determining unit 210, a motion vector difference mode reproduction unit 211, and a merge mode reproduction unit 212. A terminal 32 is connected to the bitstream analysis unit 201. A terminal 33 is connected to the motion information memory 207 A terminal 34 is connected to the motion compensator 205. A terminal 36 is connected to the motion information memory 207.

(Detailed Operation of Motion Information Reproduction Unit 204)

A description is given hereunder of a function and an operation of each component of the motion information reproduction unit 204. The inter prediction mode determining unit 210 determines whether the merge flag fed from the bitstream analysis 201 unit is “0” or “1”. If the merge flag is “0”, the inter prediction type, the reference picture index, the motion vector difference and the motion vector predictor index, which are all supplied from the bitstream analysis unit 201, will be supplied to the motion vector difference mode reproduction unit 211. If the merge flag is “1”, the merge index supplied from the bitstream analysis unit 201 will be supplied to the merge mode reproduction unit 212.

The motion vector difference mode reproduction unit 211 constructs a motion vector predictor candidate list from the inter prediction type and the reference picture index supplied from the inter prediction mode determining unit 210 as well as from the motion information on the neighboring partitions supplied through the terminal 33. Then the motion vector difference mode reproduction unit 211 selects, from the thus generated motion vector predictor candidate list, a motion vector predictor indicated by the motion vector predictor index supplied from the inter prediction mode determining unit 210. Then the motion vector difference mode reproduction unit 211 adds up the motion vector predictor and the motion vector difference, supplied from the inter prediction mode determining unit 210, thereby reproduces a motion vector, generates motion information on this motion vector, and supplies the motion information to the terminal 34 and the terminal 36.

The merge mode reproduction unit 212 constructs a merge candidate list from the motion information, on the neighboring partitions supplied, supplied through the terminal 33, selects motion information indicated by the merge index supplied from the inter prediction mode determining unit 210, from the merge candidate list, and supplies the selected motion information to the terminal 34 and the terminal 36.

(Merge Mode Reproduction Unit 212)

A detailed structure of the merge mode reproduction unit 212 is now described with reference to FIG. 20. The merge mode reproduction unit 212 includes a merge candidate list constructing unit 213 and a motion information selector 214. A terminal 35 is connected to the inter prediction mode determining unit

A description is given hereunder of a function and an operation of each component of the merge mode reproduction unit 212. The merge candidate list constructing unit 213 has the same function as that of the merge candidate list constructing unit 1400 of the moving picture coding apparatus 100, constructs a merge candidate list by performing the same operation as that of the merge candidate list constructing unit 1400, and supplies the merge candidate list to the motion information selector 214.

The motion information selector 214 selects motion information indicated by the merge index supplied through the terminal 35, from the merge candidate list supplied from the merge candidate list constructing unit 213, and then supplies the selected motion information to the terminal 34 and the terminal 36.

As described above, the moving picture decoding apparatus 200 can generate reproduction pictures by decoding the bitstreams coded by the moving picture coding apparatus 100.

### Second Embodiment

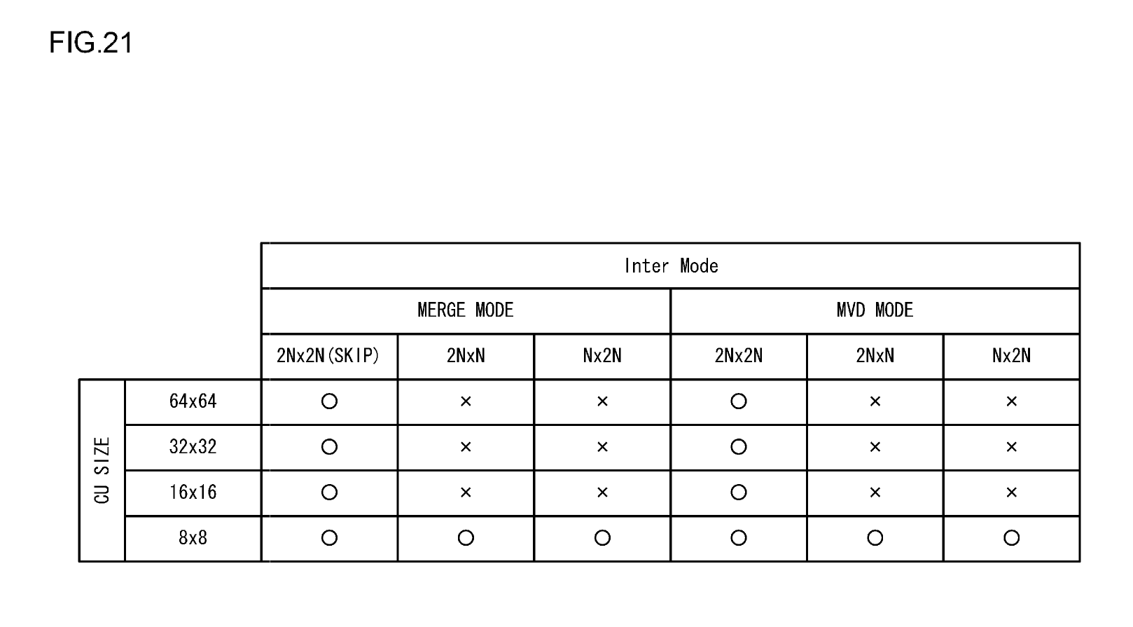

A description is given hereinbelow of a second embodiment. The inter modes usable in each CU size differ from those in the first embodiment. A description is given hereinbelow of inter modes, usable in each CU size, according to the second embodiment. FIG. 21 illustrates inter modes, usable in each CU size, according to the second embodiment. The inter modes usable in each CU size is described hereinbelow with reference to FIG. 21. The second embodiment differs from the first embodiment in that the 2N×2N motion vector difference mode is usable in 64×64 CU, which is of the maximum CU size.

In this case, as compared with the 2N×2N motion vector difference mode evaluation unit for CU whose size is not the maximum CU size, the processing amount in the 2N×2N motion vector difference mode evaluation unit for CU whose size is the maximum CU size is reduced significantly. For example, the motion is detected at a predetermined number of search points only. More specifically, the prediction errors are computed at only points indicated by the motion vector predictor contained in the motion vector predictor candidate list, and no motion is detected at the other points. In this manner, in the 2N×2N motion vector difference mode evaluating for evaluating CU having the maximum CU size, the 2N×2N motion vector difference mode is made usable as a simpler detection means than the 2N×2N motion vector difference mode evaluation unit for evaluating CU that is not of the maximum CU size. As a result, the drop in the coding efficiency can be suppressed to the minimum while the processing amount is much suppressed.

### Third Embodiment

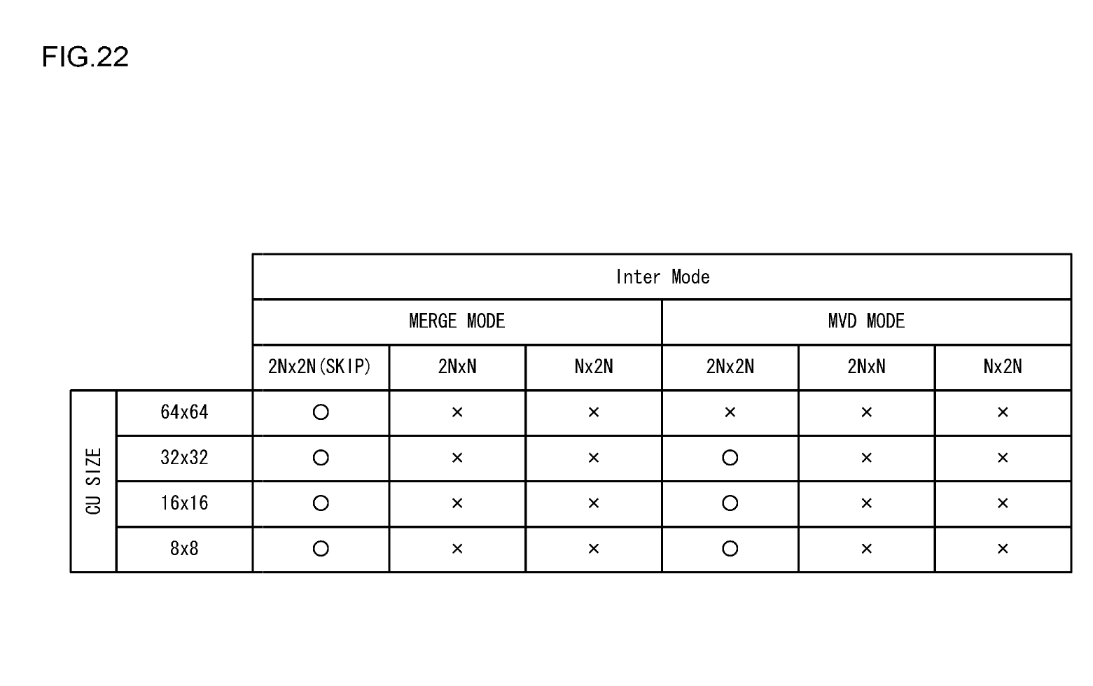

A description is given hereinbelow of a third embodiment. The inter modes usable in each CU size differ from those in the first embodiment. A description is given hereinbelow of inter modes, usable in each CU size, according to the third embodiment. FIG. 22 illustrates inter modes, usable in each CU size, according to the third embodiment. The inter modes usable in each CU size is described hereinbelow with reference to FIG. 22. The third embodiment differs from the first embodiment in that the 2N×N motion vector difference mode and the N×2N motion vector difference mode are disabled in 8×8 CU, which is of the minimum CU size. Also, a condition is set such that the slice type to which the case of FIG. 9 is applied is P slice where the bidirectional motion compensation prediction cannot be performed. The case of FIG. 22 will be applied if the slice type is B slice where the bidirectional motion compensation prediction can be performed.

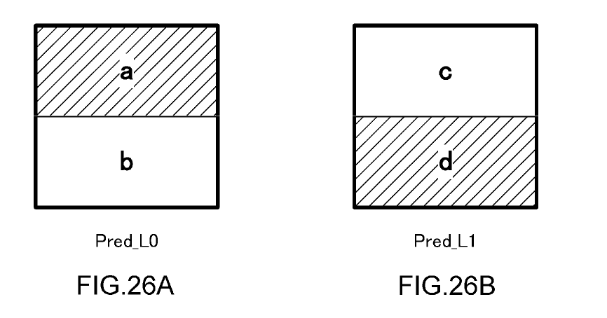

As for a B picture (B slice) where the birectional motion compensation prediction of Pred_BI can be performed, a given partition is artificially divided into two partitions even though the partition type is 2N×2N. And two items of motion information are generated, respectively, such that Pred_L0 is prioritized in the partition 0 and such that the Pred_L1 is prioritized in the partition 1. Then, the evaluation values of the two items of motion information generated are combined. As a result, the effects of 2N×N and N×2N can be achieved to a certain degree. A structure of evaluation value is described. FIGS. 26A and 26B illustrate a combination of the evaluation values of the partition 0 and the partition 1. As shown in FIG. 26A, where Pred_L0 is to be evaluated, a partition the partition type of which is 2N×2N is artificially regarded as 2N×N and is artificially divided into two partitions, namely a partition a and a partition b. As shown in FIG. 26B, where Pred_L1 is to be evaluated, a partition the partition type of which is 2N×2N is artificially regarded as N×2N and is artificially divided into two partitions, namely a partition c and a partition d. Then, D in Equation (1) is derived using the following Equation (2).

D={k(a)×SSD(a)+k(b)×SSD(b)+k(c)×SSD(c)+k(d)×SSD(d)}/2 (Equation (2))

Here, the following relations hold. That is, k(a)>k(b), k(c)<k(d), k(a)+k(b)=1, and k(c)+k(d)=1.

Accordingly, for the P slice where the bidirectional motion compensation prediction cannot be performed, the partition types of 2N×N and N×2N are used even in the minimum CU size. Also, for the B slice, the partition types of 2N×N and N×2N will not be used even in the minimum CU size.

A description has been given of the method for using the partition types depending the slice type in the minimum CU size, this should not be considered as limiting. The number of partitions usable in a slice type where the bidirectional motion can be performed is preferably set such that it is less than the number of partitions usable in a slice type where the bidirectional motion compensation prediction cannot be performed.

By employing the third embodiment as described above, the drop in the coding efficiency can be suppressed to the minimum while the processing amount is much suppressed. Also, the processing loads of P slices and B slices can be smoothed, and the scale of the moving picture coding or moving picture decoding compatible with both P slice and B slice can be suppressed.

### Fourth Embodiment

A description is given hereinbelow of a fourth embodiment. The operation of the decoding information storage 1002 differs from that in the third embodiment. A different operation of the decoding information storage 1002 from the third embodiment is now described hereinbelow. The slice type to which the case of FIG. 22 is applied is not limited to the P slice where the bidirectional motion compensation prediction cannot be performed, and the slice type thereto may be applied to the B slice where the bidirectional motion compensation prediction can be performed.

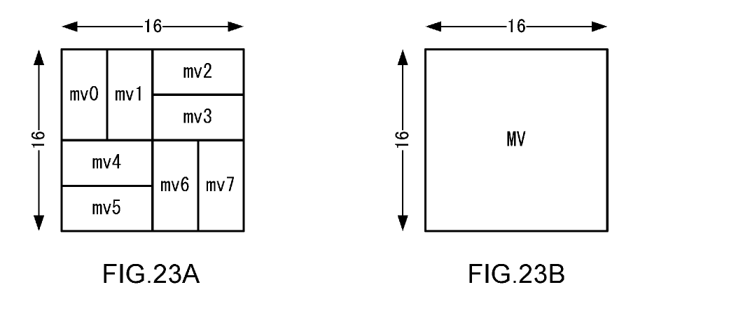

When the motion information, which serves as a reference picture, is to be stored, the motion information is replaced with a representative value of a picture of block size 16×16, which is larger than the block size 8×8, namely CU having the minimum amount of motion information. This is done for the purpose of reducing the storage capacity of motion information. FIGS. 23A and 23B illustrate how motion information is replaced with a representative value of block size 16×16. In FIGS. 23A and 23B, CTB of 16×16 is divided into eight partitions, and those eight partitions have motion vectors mv0 to mv7, respectively. The eight motion vectors are replaced with a single representative value MV. Assume here that MV is replaced with the motion vector mv0, which is an upper-left motion vector in a picture of block size 16×16.

In such a case, the motion information on the neighboring partition T of 8×8 CU in 16×16 CTB is the same. Thus, the coding efficiency of 8×8 CU is not relatively enhanced than that of CU larger than 8×8 CU.

As described above, when the motion information serving as a reference picture is stored and, in so doing, the motion information is replaced with a representative value of block size 16×16, which is larger than the block size 8×8 that is CU having the minimum amount of motion information, the partition types of 2N×N and N×2N are not used even in CU of the minimum CU size. Thereby, the drop in the coding efficiency can be suppressed to the minimum while the processing amount is much suppressed.

### Fifth Embodiment

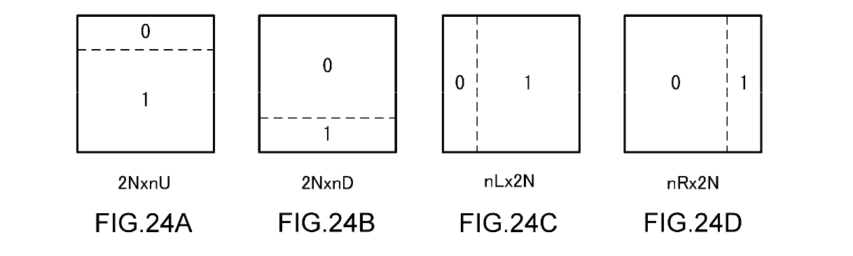

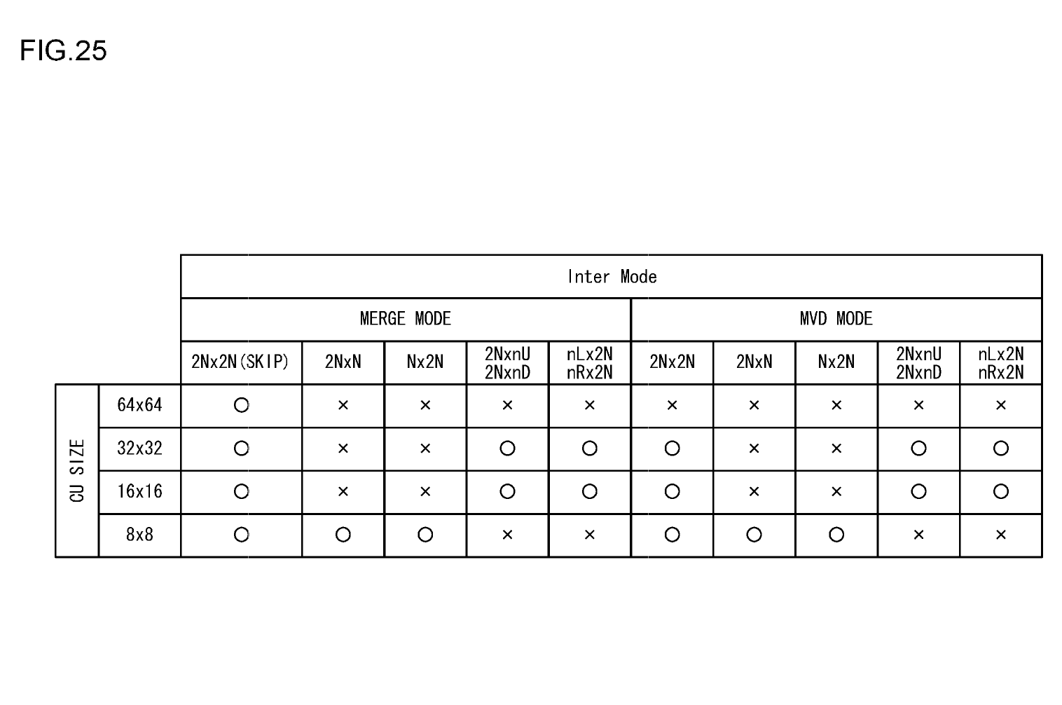

A description is given hereinbelow of a fifth embodiment. The inter modes usable in each CU size differ from those in the first embodiment. A description is given hereinbelow of inter modes, usable in each CU size, according to the fifth embodiment. FIGS. 24A to 24D illustrate new partition types in the fifth embodiment. FIG. 24A shows a partition type where a picture is vertically divided in the ratio of 1 to 3. FIG. 24B shows a partition type where it is vertically divided in the ratio of 3 to 1. FIG. 24C shows a partition type where it is horizontally divided in the ratio of 1 to 3. FIG. 24C shows a partition type where it is horizontally divided in the ratio of 3 to 1. FIG. 25 illustrates the inter modes, usable in each CU size, according to the fifth embodiment. The inter modes usable in each CU size is described hereinbelow with reference to FIG. 25. The fifth embodiment differs from the first embodiment in that a 2N×nU merge mode, a 2N×nD merge mode, an nLx2N merge mode, an nR×2N merge mode, a 2N×nU motion vector difference mode, a 2N×nD motion vector difference mode, an nL×2N motion vector difference mode, and an nR×2N motion vector difference mode are made usable in the CU having a CU size other than the minimum CU size.

As described above, in CU having a CU size other than the minimum CU size, the partition types of 2N×N and N×2N achieved by making the motion information, on two CUs obtained after the division of the CU as CTB the same are not used. Instead, the partition types where CU is divided into non-uniform-size partitions (namely, CU is not divided into two equal partitions) are used in the fifth embodiment. As a result, the duplicated or overlapped processing required for the generation of motion information on CU where a predetermined CU and the CU are divided as CTBs can be suppressed (see the description given in conjunction with FIGS. 10A and 10B) and the coding efficiency can be enhanced.

As described above, by employing the first to fifth embodiments, the motion vectors of processed blocks that neighbor a prediction block to be processed are used as the motion vectors of a block to be processed and, at the same time, the conventional method of transmitting the motion vector difference is combined. As a result, the balance (tradeoff) between the processing amount the coding efficiency can be efficiently achieved.

The moving picture bitstreams outputted from the moving picture coding apparatus according to the above-described embodiments have a specific data format so that the bitstreams can be decoded according to a decoding method used in the embodiments. Thus, a moving picture decoding apparatus compatible with the moving picture coding apparatus can decode the bitstreams of such a specific data format.

Where a wired or wireless network is used to exchange the bitstreams between the moving picture coding apparatus and the moving picture decoding apparatus, the bitstreams may be converted into a data format suitable for a transmission mode of a channel in use. In such a case, a moving picture transmitting apparatus for converting the bitstreams outputted by the moving picture coding apparatus into coding data having a data format suitable to the transmission mode of the channel and transmitting them to the network is provided, and a moving picture receiving apparatus for receiving the coding data from the network, reconstructing them into bitstreams and supplying them to the moving picture decoding apparatus is also provided.

The moving picture transmitting apparatus includes a memory for buffering the bitstreams outputted from the moving picture coding apparatus, a packet processing unit for packetizing the bitstreams, and a transmitter for transmitting the packetized coding data via the network. The moving picture receiving apparatus includes a receiver for receiving the packetized coding data via the network, a memory for buffering the received coding data, and a packet processing unit for subjecting the coding data to a packet processing so as to generate bitstreams and supply the generated bitstreams to the moving picture decoding apparatus.

It goes without saying that the coding-related and decoding-related processings as described above can be accomplished by transmitting, storing and receiving apparatuses using hardware. Also, the processings can be accomplished by firmware stored in Read Only Memory (ROM), flash memory or the like, or realized by software such as a computer. A firmware program and a software program may be recorded in a recording medium readable by a computer or the like and then made available. Also, the firmware program and the software program may be made available from a server via a wired or wireless network. Further, the firmware program and the software program may be provided through the data broadcast by terrestrial or satellite digital broadcasting.

The present invention has been described based on the exemplary embodiments. The exemplary embodiments are intended to be illustrative only, and it is understood by those skilled in the art that various modifications to constituting elements or an arbitrary combination of each process could be further developed and that such modifications are also within the scope of the present invention.

What is claimed is:

1. A moving picture coding apparatus with motion compensation prediction, the apparatus comprising:
an inter mode coding unit configured to code information regarding motion information of either one of first and second inter modes, wherein the first inter mode is a merge mode, where the motion information of a block on which the motion compensation prediction is performed is selected from a motion information candidate list derived from motion information of coded blocks, and the second inter mode is a motion vector difference mode, where a motion vector difference is coded;
a block-size information coding unit configured to code a shape of the block on which the motion compensation prediction is performed; and
an inter mode setting unit configured to set the shape of the block, on which the motion compensation prediction is performed, configured to make selectable at least one of the merge mode and the motion vector difference mode, according to the shape thereof set, and configured to determine an inter mode of information regarding the motion information to be coded by the inter mode coding unit in the selectable inter mode.

2. A moving picture coding apparatus according to claim 1, wherein, when the block on which the motion compensation prediction is performed is composed by combination of other shape, the inter mode setting unit does not select the merge mode and the motion vector difference mode.

3. A moving picture coding apparatus according to claim 1, wherein, when the size of the block on which the motion compensation prediction is performed is minimum, the inter mode setting unit sets a new shape.

4. A moving picture coding apparatus according to claim 1, wherein, when the size of the block on which the motion compensation prediction is performed is maximum, the inter mode setting unit selects the merge mode only.

5. A moving picture coding method with motion compensation prediction, the method comprising:
an inter mode coding process of coding information regarding motion information of either one of first and second inter modes, wherein the first inter mode is a merge mode, where the motion information of a block on which the motion compensation prediction is performed is selected from a motion information candidate list derived from motion information of coded blocks, and the second inter mode is a motion vector difference mode, where a motion vector difference is coded;
a block-size information coding process of coding a shape of the block on which the motion compensation prediction is performed; and
an inter mode setting process of setting the shape of the block, on which the motion compensation prediction is performed, making selectable at least one of the merge mode and the motion vector difference mode, according to the shape thereof set, and determining an inter mode of information regarding the motion information to be coded by the inter mode coding process in the selectable inter mode.

6. A non-transitory computer-readable medium storing a moving picture coding program with motion compensation prediction, the program comprising:
an inter mode coding module operative to code information regarding motion information of either one of first and second inter modes, wherein the first inter mode is a merge mode, where the motion information of a block on which the motion compensation prediction is performed is selected from a motion information candidate list derived from motion information of coded blocks, and the second inter mode is a motion vector difference mode, where a motion vector difference is coded;
a block-size information coding module operative to code a shape of the block on which the motion compensation prediction is performed; and
an inter mode setting module operative to set the shape of the block, on which the motion compensation prediction is performed, operative to make selectable at least one of the merge mode and the motion vector difference mode, according to the shape thereof set, and operative to determine an inter mode of information regarding the motion information to be coded by the inter mode coding process in the selectable inter mode.

7. A moving picture decoding apparatus comprising:
an inter mode decoding unit configured to decode information regarding motion information of either one of first and second inter modes, wherein the first inter mode is a merge mode, where the motion information of a block on which the motion compensation prediction is performed is selected from a motion information candidate list derived from motion information of coded blocks, and the second inter mode is a motion vector difference mode, where a motion vector difference is coded;
a block-size information decoding unit configured to decode block-size information where a shape of the block, on which the motion compensation prediction is performed, have been coded; and
a bitstream decoding unit configured to decode a bitstream where the information regarding the motion information of either one of the first and second inter modes has been coded, according to the block-size information.
